(19) United States
(12) Patent Application Publication
(10) Pub. No.: US 2024/0371016 A1
(43) Pub. Date: Nov. 7, 2024

(54) TIME SYNCHRONIZATION OF MULTIPLE CAMERA INPUTS FOR VISUAL PERCEPTION TASKS

(71) Applicant: QUALCOMM Incorporated, San Diego, CA (US)

(72) Inventors: Yunxiao SHI, San Diego, CA (US); Amin ANSARI, Kirkland, WA (US); Sai Madhuraj JADHAV, Foster City, CA (US); Avdhut JOSHI, San Marcos, CA (US)

(21) Appl. No.: 18/433,958

(22) Filed: Feb. 6, 2024

Related U.S. Application Data
(60) Provisional application No. 63/500,157, filed on May 4, 2023.

(51) Int. Cl. G06T 7/50; G06T 3/18; G06V 10/44

(52) U.S. Cl. CPC G06T 7/50; G06T 3/18; G06V 10/44

(57) ABSTRACT

An apparatus, method and computer-readable media are disclosed for processing images. For example, a method is provided for processing images for one or more visual perception tasks using a machine learning system including one or more transformer layers. The method includes: obtaining a plurality of input images associated with a plurality of spatial views of a scene; generating, using a machine learning-based encoder of a machine learning system, a plurality of features from the plurality of input images; and combining timing information associated with capture of the plurality of input images with at least one input of the machine learning system to synchronize the plurality of features in time.

### CROSS-REFERENCE TO RELATED APPLICATIONS

This application claims priority to U.S. Provisional Patent Application No. 63/500,157, filed May 4, 2023, which is hereby incorporated by reference, in its entirety and for all purposes.

### FIELD

The present disclosure generally relates to image processing. For example, aspects of the present disclosure are related to systems and techniques for time synchronization of multiple camera inputs for one or more visual perception tasks using a machine learning system including one or more transformer layers.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, a method is provided for processing image data (e.g., for one or more visual perception tasks using a machine learning system including one or more transformer layers). The method includes: obtaining a plurality of input images associated with a plurality of spatial views of a scene; generating, using a machine learning-based encoder of a machine learning system, a plurality of features from the plurality of input images; and combining timing information associated with capture of the plurality of input images with at least one input of the machine learning system to synchronize the plurality of features in time.

In another example, an apparatus for processing image data is provided that includes at least one memory and at least one processor coupled to the at least one memory. The at least one processor is configured to: obtain a plurality of input images associated with a plurality of spatial views of a scene; generate, using a machine learning-based encoder of a machine learning system, a plurality of features from the plurality of input images; and combine timing information associated with capture of the plurality of input images with at least one input of the machine learning system to synchronize the plurality of features in time.

In another example, a non-transitory computer-readable medium is provided that has stored thereon instructions that, when executed by one or more processors, cause the one or more processors to: obtain a plurality of input images associated with a plurality of spatial views of a scene; generate, using a machine learning-based encoder of a machine learning system, a plurality of features from the plurality of input images; and combine timing information associated with capture of the plurality of input images with at least one input of the machine learning system to synchronize the plurality of features in time.

In another example, an apparatus for processing images is provided. The apparatus includes: means for obtaining a plurality of input images associated with a plurality of spatial views of a scene; means for generating, using a machine learning-based encoder of a machine learning system, a plurality of features from the plurality of input images; and means for combining timing information associated with capture of the plurality of input images with at least one input of the machine learning system to synchronize the plurality of features in time.

In another illustrative example, a method is provided for processing image data (e.g., for one or more visual perception tasks using a machine learning system including one or more transformer layers). The method includes: obtaining a plurality of input images associated with a plurality of spatial views of a scene; generating, using a machine learning system, a plurality of predicted images associated with the plurality of spatial views; and generating a plurality of features from each of the plurality of spatial views at a first time.

In another example, an apparatus for processing image data is provided that includes at least one memory and at least one processor coupled to the at least one memory. The at least one processor is configured to: obtain a plurality of input images associated with a plurality of spatial views of a scene; generate, using a machine learning system, a plurality of predicted images associated with the plurality of spatial views; and generate a plurality of features from each of the plurality of spatial views at a first time.

In another example, a non-transitory computer-readable medium is provided that has stored thereon instructions that, when executed by one or more processors, cause the one or more processors to: obtain a plurality of input images associated with a plurality of spatial views of a scene; generate, using a machine learning system, a plurality of predicted images associated with the plurality of spatial views; and generate a plurality of features from each of the plurality of spatial views at a first time.

In another example, an apparatus for processing images is provided. The apparatus includes: means for obtaining a plurality of input images associated with a plurality of spatial views of a scene; means for generating, using a machine learning system, a plurality of predicted images associated with the plurality of spatial views; and means for generating a plurality of features from each of the plurality of spatial views at a first time.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus(es) include a camera or multiple cameras for capturing one or more images. In some aspects, the apparatus(es) include a display or multiple displays for displaying one or more images, notifications, and/or other displayable data. In some aspects, the apparatus(es) include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1A illustrates an example implementation of a system-on-a-chip (SoC), in accordance with some aspects of the disclosure;

FIG. 1B is a block diagram illustrating an example architecture of an image capture and processing system, in accordance with some aspects of the disclosure;

FIG. 2A illustrates an example of a fully connected neural network, in accordance with some aspects of the disclosure;

FIG. 2B illustrates an example of a locally connected neural network, in accordance with some aspects of the disclosure;

FIG. 2C illustrates an example of a convolutional neural network (CNN), in accordance with some aspects of the disclosure;

FIG. 3 is a diagram illustrating an example of an attention-based machine learning architecture that can be used to generate one or more visual perception task outputs based on an input image data that includes multiple views, in accordance with some aspects of the disclosure;

FIG. 4 is a diagram illustrating an example transformer-based machine learning network that can be used to determine attention using a plurality of multi-headed self-attention (MHSA) layers that are associated with exponential computational complexity O(n2) with respect to input sequence length, in accordance with some aspects of the disclosure;

FIG. 5 is a diagram illustrating an example transformer-based machine learning network that includes linear transformer layers that can be used to perform cross-view feature processing with a linear computational complexity, in accordance with some aspects of the disclosure;

FIG. 6 is a diagram illustrating an example view partitioning that can be used to determine attention for performing a machine learning-based visual perception task, in accordance with some aspects of the disclosure;

FIG. 7 is a block diagram of a self-supervised vision system configured to determine a depth using structure-from-motion principles in time in accordance with some aspects of the disclosure;

FIG. 8 is a block diagram of a self-supervised vision system configured to align features of multiple observations in time in accordance with some aspects of the disclosure;

FIG. 9 is a detailed block diagram of a self-supervised vision system that uses structure-from-motion principles and temporal synchronization in accordance with some aspects of the disclosure;

FIG. 10 is a block diagram of a self-supervised vision system configured to align features of multiple images in time in accordance with some ç;

FIG. 11 is a flow diagram illustrating an example of a process for processing image and/or video data, in accordance with some aspects of the disclosure; and

FIG. 12 is a flow diagram illustrating an example of a process for processing image and/or video data, in accordance with some aspects of the disclosure; and

FIG. 13 is a block diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Machine learning networks can be used to perform various visual perception tasks (e.g., also referred to as “visual recognition tasks”). For example, a machine learning network can be used to perform visual perception tasks that include depth estimation and/or depth map generation, image segmentation and/or semantic segmentation, object detection and/or classification, optical flow estimation and/or optical flow map generation, among others. In some cases, a machine learning network can be trained to perform one or more visual perception tasks based on input(s) that include image data of a scene. Image data of a scene can include still images captured by a camera. Image data may also include a series of still images (e.g., video frames) captured by a camera.

In some examples, a machine learning network can be trained to perform one or more visual perception tasks using image data captured by a single camera. In some aspects, image data captured by a single camera may be associated with a fixed or static spatial viewpoint (e.g., if the single camera remains stationary relative to the scene being captured in the image data). In some examples, a machine learning network can be trained to perform the one or more visual perception tasks using spatially distributed image data captured by one or more cameras (e.g., multiple spatial viewpoints may be represented in the input image data).

For example, a single camera that is moving relative to the scene being captured in the image data may capture spatially distributed image data (e.g., different spatial viewpoints are represented in the image data captured at different times). In some examples, multiple cameras can be used to capture spatially distributed image data. Some (or all) of the multiple cameras used to capture spatially distributed image data may be associated with a fixed or static spatial viewpoint. In some examples, some (or all) of the multiple cameras used to capture spatially distributed image data may be moving through or moving relative to the scene being captured in the spatially distributed image data.

In some aspects, spatially distributed image data can be obtained from multiple cameras that are included on a vehicle (e.g., an autonomous vehicle, semi-autonomous vehicle, etc.) or otherwise associated with a vehicle. For example, spatially distributed image data can be obtained from multiple cameras that are included in a driver assistance system (DAS) and/or an advanced driver assistance system (ADAS). In some examples, spatially distributed image data can be obtained from multiple cameras that are included on an extended reality (XR) or augmented reality (AR) device or headset, from multiple cameras that are included on a smartphone or mobile computing device, from multiple cameras that are included on an Internet-of-Things (IoT) device, etc.

In some cases, machine learning-based visual perception tasks that utilize spatially distributed input image data as input may be associated with improved performance in the visual perception task. For example, when spatially distributed input image data is utilized, some portions of the scene being analyzed may be observed multiple times. These multiple observations may be multiple spatial observations (e.g., a portion of the scene is observed from multiple different spatial viewpoints/cameras at a given time) and/or may be multiple temporal observations (e.g., a portion of the scene is observed from a given spatial viewpoint at multiple different times). In some examples, the multiple observations may include multiple spatial-temporal observations, wherein a portion of the scene is observed from multiple different viewpoints across multiple different times.

In one illustrative example, the multiple observations (e.g., also referred to as “multiple views”) associated with spatially distributed input image data can be fused to improve the accuracy of the visual perception task performed using a machine learning network. For example, when the visual perception task is a depth perception task (e.g., such as depth estimation, depth map generation, etc.), depth estimates can be determined for the individual views and fused to obtain a depth estimate over the multiple views. In some examples, multiple views can be used to perform visual perception tasks that cannot be performed using only a single view. For example, a depth estimation based on parallax can be performed using the multiple views included in spatially distributed input image data but may be difficult or impossible to perform using a single view input image data.

In some cases, multiple observations may be required for a true understanding of the environment by a device. In the case of an autonomous vehicle, a full representation of the surrounding environment is necessary for the autonomous vehicle to navigate the environment. As an example, an autonomous vehicle needs to be able to identify a possible path of an object that may intersect with the autonomous vehicle and navigate the environment to prevent a potential collision with the object. In the case of an autonomous vehicle, the autonomous vehicle includes a plurality of sensors to capture the environment in 360° and identify the objects within the images.

In some cases, the depths of objects can be detected in an image sequence using structure-for-motion principles. In one example, structure from motion uses a plurality of images (e.g., three images from a single camera) to predict the depth of objects in a target frame. In one example, a center image of a sequence of three images is treated as a target image (e.g., a target frame), and a depth map is generated for the target image based on the images before and after the target image, which is referred to as the source frames. In this case, a photometric error can be computed based on a synthesized target frame and the depth map to generate a photometric error can be used as a system objective to optimize the computer vision system.

Multi-camera depth estimation requires multiple image sensors to detect the full environment. Depth estimation can be performed using each depth estimate from each separate camera, such as by combining the depth estimates to form a representation of the entire scene. Combining separate depth estimates from each image sensor does not work because there are spatial correlation, context correlation, or view overlap between each image sensor, and fusing the information is impractical based on differences in timing, view overlap, and so forth. In some cases, multi-head self-attention has been proposed to capture the spatial context between image sensors. Multi-head self-attention is a computationally heavy process and does not account for various differences that are inherent, such as not all cameras having an identical view overlap or the same camera position (e.g., vertical position relative to the ground surface).

In some cases, a spatial loss may be used to synthesize the multiple observations. The extrinsic information of the multi-image sensor system is known, a spatial photometric error is introduced by warping images produced by neighboring image sensors to converge a single view representative of the environment. In a non-limiting example of an autonomous vehicle, images can be fused to create a 360° view of the autonomous vehicle.

Image sensors are not synchronized in time due to various effects. For example, cameras that support a trigger mode only start to capture the image in response to the image. The length of the exposure of each image may be set dynamically based on the scene, lighting, and other environmental considerations. In this case, images produced as part of the multiple observations will not be synchronized and features within the image will be different. In addition, each image sensor will have various parasitic differences such as temperature distortions (e.g., lens distortion), hardware faults, physical damage, clock drift, and so forth, which can cause image sensors at the same timestep to capture images at different times.

Systems, apparatuses, processes (also referred to as methods), and computer-readable media (collectively referred to as “systems and techniques”) are described herein for performing one or more visual perception tasks based on combining timing information associated with the capture of the plurality of input images with at least one input to a machine learning system to synchronize a plurality of features in time. In one aspect, the machine learning system may be generative network (e.g., a conditional generative adversarial networks (GAN)) including machine learning-based cross-view attention such as a self-attention determined using one or more transformer-based layers included in a machine learning network. In some aspects, the machine learning system combines timing information associated with the plurality of input images and synchronizes a plurality of features in different images in time. For example, the depth of a feature that is present in an overlapping view of different image sensors can be detected using the systems and techniques described herein.

In some examples, the machine learning-based cross-view attention can be a cross-attention determined using one or more transformer-based layers included in a machine learning network. For example, self-attention can be determined using one or more transformer-based layers that receive a query (Q), key (K), and value (V) input that is obtained from the same embedding sequence (e.g., obtained from the same set of features). Cross-attention can be determined using one or more transformer-based layers that receive a query input from a first embedding sequence and receive key and value inputs from a second embedding sequence that is different than the first embedding sequence.

In one illustrative example, the systems and techniques can be used to perform one or more visual perception tasks based on a series of camera inputs that overlap at least partially in space and/or in time. For example, the systems and techniques can receive as input spatially distributed input image data that includes multiple views and/or multiple spatial viewpoints. The multiple views and/or multiple spatial viewpoints can be captured using a plurality of image sensors at different times due to parasitic effects and image sensor settings such as an exposure time. For example, the depth of a feature that is present in an overlapping view of different image sensors can be detected using the systems and techniques described herein.

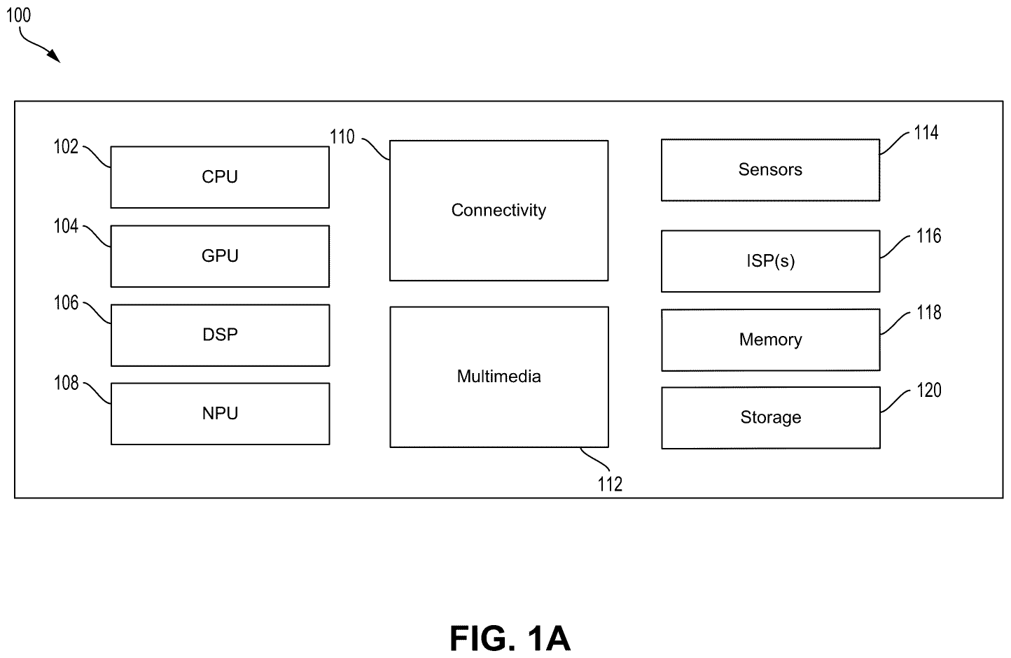

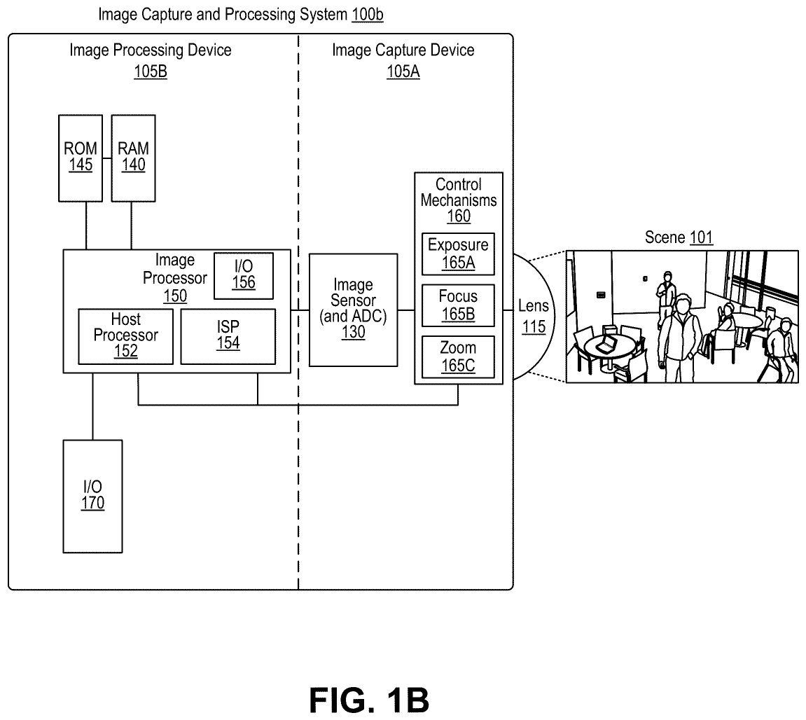

Various aspects of the present disclosure will be described with respect to the figures. FIG. 1A illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform semantic image segmentation according to aspects of the present disclosure. In some cases, by using neural network architectures such as transformers and/or shifted window transformers in determining one or more segmentation masks, aspects of the present disclosure can increase the accuracy and efficiency of semantic image segmentation.

FIG. 1B is a block diagram illustrating an architecture of an image capture and processing system 100b. The image capture and processing system 100b includes various components that are used to capture and process images of scenes (e.g., an image of a scene 101). The image capture and processing system 100b can capture standalone images (or photographs) and/or can capture videos that include multiple images (or video frames) in a particular sequence. A lens 115 of the system 100b faces a scene 101 and receives light from the scene 101. The lens 115 bends the light toward the image sensor 130. The light received by the lens 115 passes through an aperture controlled by one or more control mechanisms 160 and is received by an image sensor 130.

The one or more control mechanisms 160 may control exposure, focus, and/or zoom based on information from the image sensor 130 and/or based on information from the image processor 150. The one or more control mechanisms 160 may include multiple mechanisms and components; for instance, the control mechanisms 160 may include one or more exposure control mechanisms 165A, one or more focus control mechanisms 165B, and/or one or more zoom control mechanisms 165C. The one or more control mechanisms 160 may also include additional control mechanisms besides those that are illustrated, such as control mechanisms controlling analog gain, flash, HDR, depth of field, and/or other image capture properties.

The focus control mechanism 165B of the control mechanisms 160 can obtain a focus setting. In some examples, focus control mechanism 165B store the focus setting in a memory register. Based on the focus setting, the focus control mechanism 165B can adjust the position of the lens 115 relative to the position of the image sensor 130. For example, based on the focus setting, the focus control mechanism 165B can move the lens 115 closer to the image sensor 130 or farther from the image sensor 130 by actuating a motor or servo, thereby adjusting focus. In some cases, additional lenses may be included in the system 100b, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 160, the image sensor 130, and/or the image processor 150. The focus setting may be referred to as an image capture setting and/or an image processing setting.

The exposure control mechanism 165A of the control mechanisms 160 can obtain an exposure setting. In some cases, the exposure control mechanism 165A stores the exposure setting in a memory register. Based on this exposure setting, the exposure control mechanism 165A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 165C of the control mechanisms 160 can obtain a zoom setting. In some examples, the zoom control mechanism 165C stores the zoom setting in a memory register. Based on the zoom setting, the zoom control mechanism 165C can control a focal length of an assembly of lens elements (lens assembly) that includes the lens 115 and one or more additional lenses. For example, the zoom control mechanism 165C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 101 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 165C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 160 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1310 discussed with respect to the computing system 1300. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image downsampling, pixel interpolation, automatic exposure (AE) control, automatic gain control (AGC), CDAF, PDAF, automatic white balance, merging of images to form an HDR image, image recognition, object recognition, feature recognition, receipt of inputs, managing outputs, managing memory, or some combination thereof. The image processor 150 may store images and/or processed images in random access memory (RAM) 1325, read-only memory (ROM) 1320, a cache 1312, a memory unit (e.g., system memory 1315), another storage device 1330, or some combination thereof.

Various input/output (I/O) devices 170 may be connected to the image processor 150. The I/O devices 170 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 170, or through a virtual keyboard or keypad of a touchscreen of the I/O devices 170. The I/O 156 may include one or more ports, jacks, or other connectors that enable a wired connection between the system 100b and one or more peripheral devices, over which the system 100b may receive data from the one or more peripheral device and/or transmit data to the one or more peripheral devices. The I/O 156 may include one or more wireless transceivers that enable a wireless connection between the system 100b and one or more peripheral devices, over which the system 100b may receive data from the one or more peripheral device and/or transmit data to the one or more peripheral devices. The peripheral devices may include any of the previously-discussed types of I/O devices 170 and may themselves be considered I/O devices 170 once they are coupled to the ports, jacks, wireless transceivers, or other wired and/or wireless connectors.

In some cases, the image capture and processing system 100b may be a single device. In some cases, the image capture and processing system 100b may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1B, a vertical dashed line divides the image capture and processing system 100b of FIG. 1B into two portions that represent the image capture device 105A and the image processing device 105B, respectively. The image capture device 105A includes the lens 115, control mechanisms 160, and the image sensor 130. The image processing device 105B includes the image processor 150 (including the ISP 154 and the host processor 152), the RAM 140, the ROM 145, and the I/O 156. In some cases, certain components illustrated in the image capture device 105A, such as the ISP 154 and/or the host processor 152, may be included in the image capture device 105A.

The image capture and processing system 100b can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100b can include one or more wireless transceivers for wireless communications, such as cellular network communications, 802.11 Wi-Fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100b is shown to include certain components, one of ordinary skill will appreciate that the image capture and processing system 100b can include more components than those shown in FIG. 1B. The components of the image capture and processing system 100b can include software, hardware, or one or more combinations of software and hardware. For example, in some implementations, the components of the image capture and processing system 100b can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100b.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past images. The host processor 152 can also dynamically configure the parameter settings of the internal pipelines or modules of the ISP 154 to match the settings of one or more input images from the image sensor 130 so that the image data is correctly processed by the ISP 154. Processing (or pipeline) blocks or modules of the ISP 154 can include modules for lens (or sensor) noise correction, de-mosaicing, color conversion, correction or enhancement/suppression of image attributes, denoising filters, sharpening filters, among others. Each module of the ISP 154 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In general, ML can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

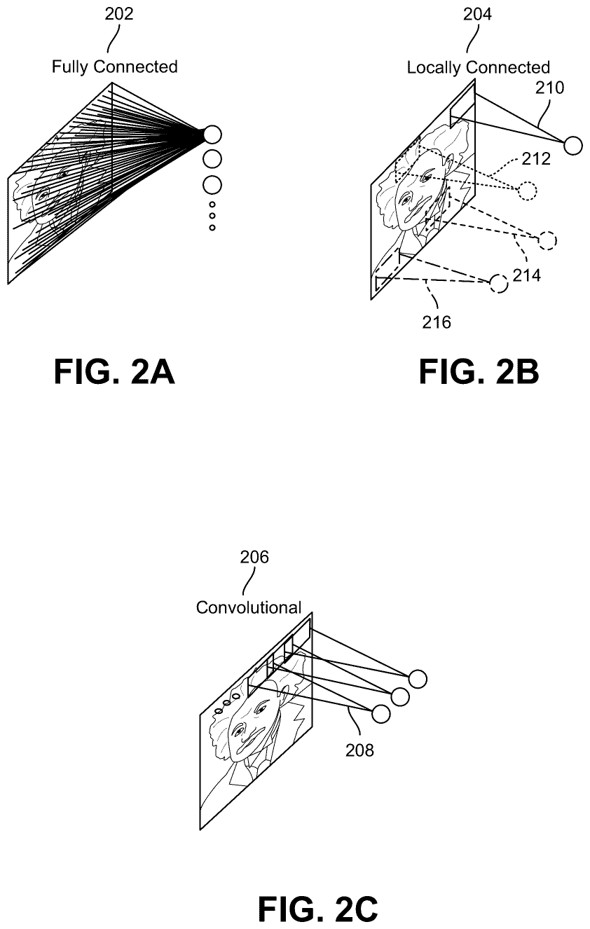

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, as the higher layer neurons in a given region may receive inputs that are tuned through training to the properties of a restricted portion of the total input to the network.

One example of a locally connected neural network is a convolutional neural network (CNN). FIG. 2C illustrates an example of a convolutional neural network 206. The convolutional neural network 206 may be configured such that the connection strengths associated with the inputs for each neuron in the second layer are shared (e.g., shown as connections 208). Convolutional neural networks may be well suited to problems in which the spatial location of inputs is meaningful. Convolutional neural network 206 may be used to perform one or more aspects of video compression and/or decompression, according to aspects of the present disclosure.

As mentioned previously, systems and techniques are described herein for performing machine learning-based cross-view attention for one or more visual perception tasks based on spatially distributed views. For example, the systems and techniques can be used to perform one or more visual perception tasks based on a series of camera inputs that overlap at least partially in space and/or in time. In some aspects, the systems and techniques can perform the one or more visual perception tasks based on machine learning-based cross-view attention having a computational complexity that is linear with an input image resolution. In some examples, the machine learning-based cross-view attention can be implemented using one or more transformer layers and/or transformer-based neural networks.

A transformer is a type of deep learning model that utilizes an attention mechanism to differentially weight the significance of each part of the input data and model long-range dependencies. For example, transformers can use the attention mechanism to determine global dependencies between input and output sequences. A transformer may utilize an encoder-decoder architecture. The encoder can include a plurality of encoder layers to process an input sequence iteratively, one layer after another. The decoder can include a plurality of decoder layers to process the encoder output sequence iteratively, one layer after another (e.g., the encoder output is provided as an input to the decoder). Each encoder and decoder layer can include an attention mechanism. For each portion of an input, attention can be used to weight the relevance of every other portion of the input and generate a corresponding output. Decoder layers can include an additional attention mechanism that utilizes information from decoder output(s) at previous time steps. For example, a decoder layer can include an attention mechanism for processing information from decoder outputs at previous time steps, prior to an attention mechanism included in the decoder for processing information from the encodings (e.g., generated by the encoder layer(s)) associated with the current time step.

A transformer can include a feed-forward neural network component in both the encoder and the decoder layers. For example, a feed-forward neural network component can be provided between the attention mechanism included in the encoder layers and the output of the encoder layers, and a feed-forward neural network component can be provided between the attention mechanism included in the decoder layers and the output of the decoder layers. In some examples, the feed-forward neural network may be implemented as a multi-layer perceptron (MLP), among other types of feed-forward neural networks.

In some examples, a transformer can determine attention weights between all tokens simultaneously (e.g., wherein the tokens correspond to features or embeddings, etc.). For example, an attention layer can generate an embedding for each respective token such that the embedding includes (or is otherwise indicative of) information associated with the respective token and a weighted combination of other relevant tokens associated with the respective token. The other relevant tokens associated with the respective token may each be weighted by a corresponding attention weight (e.g., wherein the attention weight is indicative of the weight or strength of the association between the relevant token and the respective token).

An attention layer can be trained to learn three attention weighting matrices, given as a query weights matrix W_{Q}, a key weights matrix W_{K}, and a value weights matrix W_{V}. For each given token i, the corresponding token embedding xᵢ is multiplied by the three attention weighting matrices to produce a query vector qᵢ=xᵢW_{Q}, a key vector kᵢ=xᵢW_{K}, and a value vector vᵢ=xᵢW_{V}. Attention weights can be determined based on the query vector qᵢ and the key vector kᵢ. For example, the attention weight aᵢⱼ from token i to token j can be determined as the dot product between qᵢ and kⱼ.

Based on the query weights matrix, W_{Q}, and the key weights matrix, W_{K}, being provided as two separate matrices, attention can be non-symmetric. For example, the attention weight aᵢⱼ can be determined as the dot product qᵢ·kⱼ and represents the attention from token i to token j. When attention is non-symmetric, the attention weight aᵢⱼ can be different than the attention weight aⱼᵢ (e.g., the attention weight from token j to token i), which can be determined as the dot product qⱼ·kᵢ.

The output of a transformer attention layer for a given token i is the weighted sum of the value vectors (e.g., vᵢ) of all tokens, weighted by aᵢⱼ, the attention from token i to each of the j additional tokens. For example, an attention layer can determine attention values by computing a matrix of outputs as:

$$Attention ( Q , K , V ) = softmax ( \frac{Q {K}^{T}}{\sqrt{{d}_{k}}} ) V$$

Here, the matrix Q is the matrix including all of the i query vectors qᵢ as row entries; the matrix K is the matrix including all of the i key vectors kᵢ as row entries; and the matrix V is the matrix including all of the i value vectors vᵢ as row entries. For example, Q=W_{q}·X; K=Wₖ·X; and V=Wᵥ·X. In some aspects, when the inputs to Q, K, V are the same X, the attention computation is a “self” attention. When the inputs to Q, K, V are not the same X, the attention computation is a “cross” attention. For example, self-attention can be determined by using the same embedding sequence X as input to Q, K, and V. Cross-attention can be determined by using a first embedding sequence X₁ as input to Q and a second embedding sequence X₂ as input to K and V.

The W_{q}, Wₖ, and Wᵥ terms are linear layers that project or map the input vector X to the query (Q), key (K), and value (V) matrices. The term dₖ refers to a dimension of a key k, with \sqrt{dₖ} acting as a scaling factor. Softmax refers to a softmax function that is used obtain weights on the self-attention values. The layer norm can output the weights to the feedforward neural network component described previously above, as being provided prior to or at the output of the transformer encoder layers and the output of the transformer decoder layers.

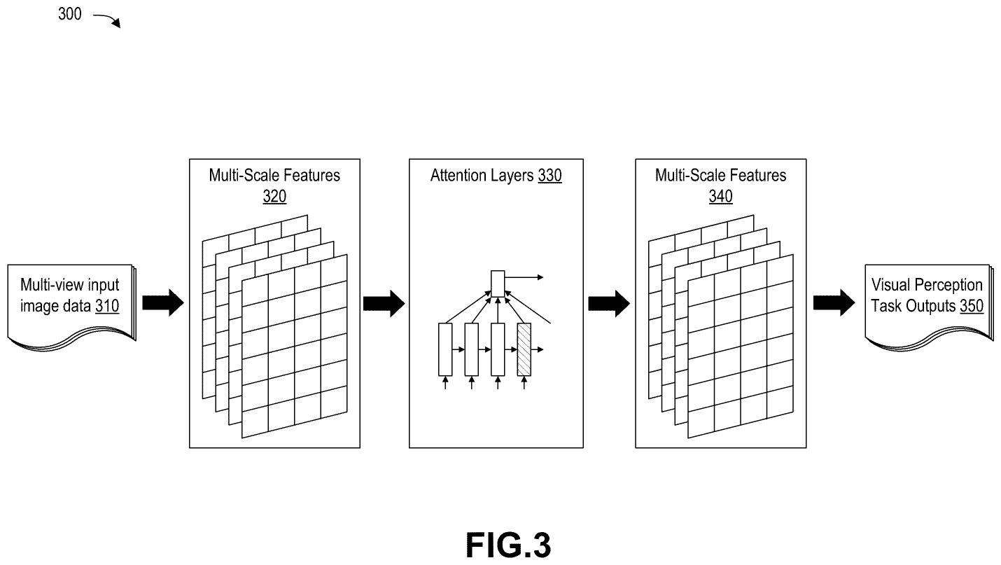

FIG. 3 is a diagram illustrating an example of an attention-based machine learning architecture 300 that can be used to generate one or more visual perception task outputs 350 based on an input image data 310 that includes multiple views. For example, the input image data 310 can be a spatially distributed input image data that includes multiple views captured using multiple cameras each associated with a respective spatial viewpoint and/or that includes multiple views captured using one or more cameras over time. In one illustrative example, the input image data 310 can be obtained using multiple cameras that capture multiple views with at least a partial view overlap between two or more cameras included in the multiple cameras. In another illustrative example, the input image data 310 can be obtained using one or more cameras that capture video data and/or other sequences of images or frames over time, wherein the video data and/or image sequences have at least a partial overlap.

For example, the multi-view (e.g., spatially distributed input image data 310) can be obtained using multiple cameras mounted on or otherwise included in a car or other vehicle, multiple cameras mounted on or otherwise included in an XR or AR headset and/or system, multiple cameras mounted on or otherwise included in a smartphone or other mobile computing device, multiple cameras included in an IoT camera network, multiple cameras included on one or more drones and/or a network of drones, etc.

The example attention-based machine learning architecture 300 can generate a plurality of multi-scale features 320 corresponding to the multi-view input image data 310. For example, the multi-scale features 320 can be generated by providing the multi-view input image data 310 to one or more encoders. In some aspects, the multi-scale features 320 can be generated by providing the multi-view input image data 310 to one or more neural networks, including CNNs, RNNs, etc. For example, the multi-scale features 320 can be feature or embeddings generated as output by an image classification neural network, etc.

The multi-scale features 320 can be provided as input to one or more attention layers 330. In one illustrative example, the one or more attention layers 330 can be included in one or more transformer-based machine learning networks and/or can be included in one or more transformer layers of a machine learning network. For example, the attention layers 330 can determine self-attention and/or cross-attention between the multi-scale features 320, as described previously above. For example, the multi-scale features 320 can include a separate set of features for each camera or spatial viewpoint included in the multi-scale features 320. In some cases, the multi-scale features 320 can include a single set of features that is a concatenation of the features generated for each camera or spatial viewpoint included in the multi-scale features 320.

Based on the attention calculation implemented using the attention layers 330, a plurality of multi-scale attention features 340 can be generated as output. For example, the multi-scale attention features 340 can correspond to or be indicative of an output of a given visual perception task (e.g., depth estimation, image segmentation, object detection, optical flow, etc.) performed using the example attention-based machine learning architecture 300. In some cases, the multi-scale attention features 340 can be used to generate or otherwise determine one or more visual perception task outputs 350 (e.g., illustrated in FIG. 3 as depth estimation or depth map outputs, corresponding to an example in which the attention-based machine learning architecture 300 is used to perform a depth estimation visual perception task).

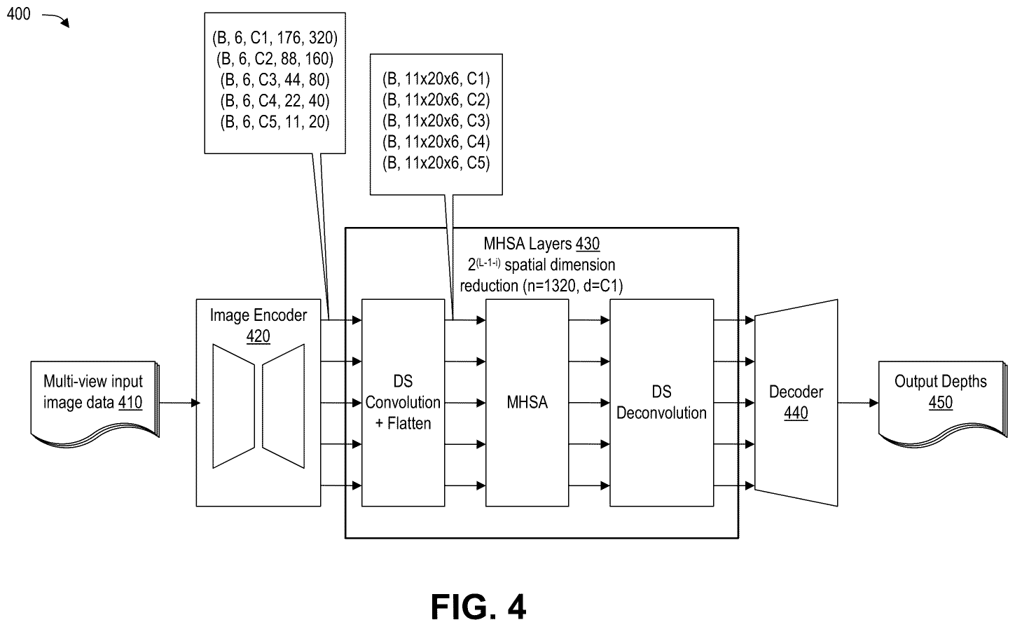

As mentioned previously, computing self-attention for the multi-view input image data 310 can be associated with exponential computational complexity that incurs a complexity of O(n²) with respect to sequence length (e.g., the sequence length of the multi-scale features 320 provided as input to attention layers 330). FIG. 4 is a diagram illustrating an example transformer-based machine learning network 400 that determines attention using a plurality of multi-headed self-attention (MHSA) layers 430 that are associated with exponential computational complexity O(n²) with respect to input sequence length. In some aspects, the plurality of MHSA layers 430 can receive as input a multi-view (e.g., spatially distributed) input image data 410, which can be the same as or similar to the multi-view input image data 310 illustrated in FIG. 3. In some examples, the plurality of MHSA layers 430 can be the same as or similar to the one or more attention layers 330 illustrated in FIG. 3. A visual perception task output 450 can be the same as or similar to the visual perception task output 350 illustrated in FIG. 3.

The multi-view input image data 410 can be RGB image data or image data captured in various other color spaces. As illustrated, the multi-view input image data 410 can be RGB image data captured by six different cameras (e.g., or otherwise including six different views). The multi-view input image data 410 can include three channels (e.g., a red (R) channel, a blue (B) channel, and a green (G) channel), each having dimensions of 352×640. In some examples, the dimension parameters of the multi-view input image data 410 can be given in pixels (e.g., 352 pixels in height and 640 pixels in width, or vice versa). For example, as depicted in FIG. 4, the multi-view input image data 410 is indicated as (B, 6, 3, 352, 640) multi-view input image data. Here, the parameter B can indicate a batch size. For example, the multi-view input image data 410 can be associated with a batch size of B=1, indicating that the 352×640 pixel data represents the entirety of each image. In other examples, the multi-view input image data 410 can be associated with a batch size of B=2, indicating that the 352×640 pixel data represents ½ of each image (e.g., for a batch size B=2, each full-resolution input image can be processed by dividing the full-resolution input image into two equal sized batches).

The multi-view input image data 410 can include an input image associated with each view of the multiple views for each time step. For example, when multi-view input image data 410 is associated with or includes six different cameras/views, the multi-view input image data 410 can include six different images at each time step. For each time step, the multi-view input image data 410 can be provided as input to an image encoder 420, which generates as output a corresponding set of features or embeddings associated with the multi-view input image data 410. For example, in some cases, the image encoder 420 can be a CNN implementing a ResNet architecture. In one illustrative example, the image encoder 420 can implement the ResNet34 architecture.

The plurality of MHSA layers 430 can include a plurality of different scales. For example, as illustrated, the plurality of MHSA layers 430 can include five different scales. A first scale is depicted as the top row of the plurality of MHSA layers 430, having dimensions (B, 6, C1, 176, 320). In some aspects, the parameter B can represent a batch size, and may be the same as the batch size associated with the multi-view input image data 310. In one illustrative example, the first scale can receive as input the image features (e.g., generated from the multi-view input image data 410 using image encoder 420) associated with the six different views and having C1 different channels, each having a dimension of 176×320. In some aspects, C1 can be greater than or equal to three (e.g., based on the image features generated by image encoder 420 having a greater dimensionality or channel quantity than the three RGB channels included in the multi-view input image data 410. In some examples, the first scale can have channels with dimensions that are half the size of the multi-view input image data 410 dimensions.

A second scale included in the plurality of MHSA layers 430 has dimensions (B, 6, C2, 88, 160). For example, the second scale can receive as input a set of features associated with the same six views and having C2 different channels, each having a dimension of 88×160. In some aspects, the quantity of channels C2 included in the second scale of MHSA layers 430 can be greater than the quantity of channels C1 included in the first scale of MHSA layers 430. In some cases, the input to the second scale can be the same as or based on the output of the first scale. In some examples, the input to the second scale can be generated based on or obtained from the set of image features generated by the image encoder 420. In some examples, the second scale can have channels with dimensions that are half the size of the channels included in the first scale (e.g., 88×160 and 176×320, respectively).

A third scale included in the plurality of MHSA layers 430 has dimensions (B, 6, C3, 44, 80). The third scale can receive as input a set of features associated with the same six views and having C3 different channels, each having a dimension of 44×80. In some examples, C3>C2>C1>3. As illustrated, the third scale can have channels with dimensions that are half the size of the channels included in the second scale (e.g., 44×80 and 88×160, respectively).

A fourth scale included in the plurality of MHSA layers 430 has dimensions (B, 6, C4, 22, 40). The fourth scale can receive as input a set of features associated with the same six views and having C4 different channels, each having a dimension of 22×40. In some examples, C4>C3>C2>C1>3. As illustrated, the fourth scale can have channels with dimensions that are half the size of the channels included in the third scale (e.g., 22×40 and 44×80, respectively).

A fifth scale included in the plurality of MHSA layers 430 has dimensions (B, 6, C5, 11, 20). The fifth scale can receive as input a set of features associated with the same six views and having C5 different channels, each having a dimension of 11×20. In some examples, C5>C4>C3>C2>C1>3. As illustrated, the fifth scale can have channels with dimensions that are half the size of the channels included in the fourth scale (e.g., 11×20 and 22×40, respectively).

In some examples, the respective scales included in the plurality of MHSA layers 430 (e.g., the first through fifth scales) can be associated with a 2^{(L-1-i)} reduction in spatial dimensions, where L represents the total quantity of scales (e.g., L=5 in the example of FIG. 4) and i represents the i-th scale included in the plurality of MHSA layers 430. For example, as described above, the spatial dimensions of the channels included in consecutive scales can be reduced by a factor of ½ (e.g., 2⁻¹).

In some examples, a greater or lesser quantity of scales can be included in or implemented by the plurality of MHSA layers 430. For example, a greater or lesser reduction in spatial dimensions of the channels can be applied (e.g., greater or lesser than ½) between consecutive scales. In some aspects, the spatial dimensions of the final scale included in the plurality of MHSA layers 430 can be equal to the spatial dimensions of the features provided as input to the MHSA included in each respective scale. For example, as illustrated in FIG. 4, the spatial dimensions of the fifth scale can be 11×20, which is the same as the 11×20 spatial dimension utilized as input to the MHSA included in each of the five scales.

In some aspects, each of the different scales (e.g., the five different scales illustrated in FIG. 4) included in the plurality of MHSA layers 430 can include one or more convolution and flattening layers. For example, the convolution layer(s) can be provided as depth-wise separable (DS) convolution layer(s). The input features to each scale can be provided as input to the one or more convolution and flattening layers, which generate as output a corresponding set of spatially reduced features having the same quantity of channels. For example, the one or more convolution and flattening layers included in the first scale can receive as input features with dimensions (B, 6, C1, 176, 320) and generate as output a set of spatially reduced features with dimensions (B, 11×20×6, C1), the one or more convolution and flattening layers included in the second scale can receive as input features with dimensions (B, 6, C2, 88, 160) and generate as output a set of spatially reduced features (B, 11×20×6, C2), etc.

As illustrated in FIG. 4, the set of spatially reduced features provided as input to the MHSA included in each scale can be characterized by n=1320 and d=Ci (e.g., each set of spatially reduced features includes 11*20*6=1320 features, having a quantity of dimensions/channels equal to Ci).

The MHSA included in each scale can calculate a multi-headed self-attention across the 1,320 features, with a computational complexity of O(n²) relative to the input resolution of the multi-view input image data 410. The output of the MHSA included in each scale (e.g., the self-attention) can be provided to one or more deconvolution layers. For example, the one or more deconvolution layers can be provided as depth-wise sparable (DS) deconvolution layers.

A decoder 440 can receive as input the attention (e.g., self-attention) determined using the scales included in the plurality of MHSA layers 430. Based on this attention (e.g., self-attention) information calculated for the multi-view input image data 410, decoder 440 can generate one or more visual perception task outputs 450. For example, when the visual perception task is a depth estimation visual perception task, decoder 440 can generate one or more depth maps or other depth estimates as the visual perception task outputs 450. In some aspects, the plurality of MHSA layers 430 can be included in one or more transformer-based encoder layers of the example transformer-based machine learning network 400 and the decoder 440 can be implemented using one or more corresponding transformer-based decoder layers of the example transformer-based machine learning network 400 (e.g., as described above with respect to the encoder-decoder transformer architecture).

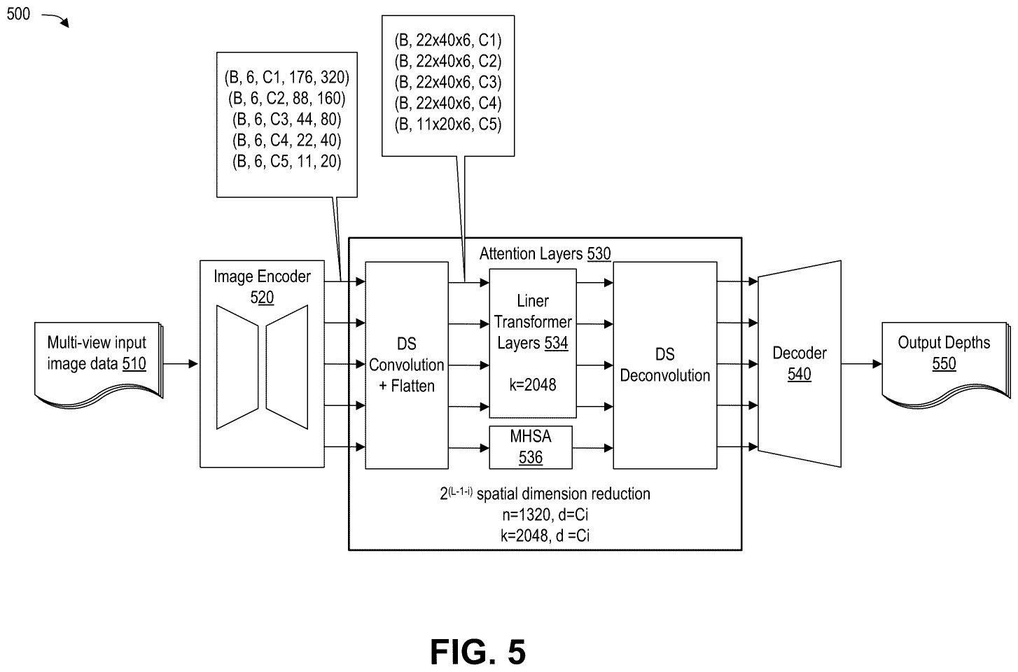

FIG. 5 is a diagram illustrating an example transformer-based machine learning network 500 that includes linear transformer (e.g., linformer) layers that can be used to perform cross-view feature processing with a linear computational complexity. In one illustrative example, the transformer-based machine learning network 500 can be used to determine cross-view attention for performing one or more visual perception tasks based on a multi-view input image data 510. In some aspects, the multi-view input image data 510 can be the same as or similar to one or more (or both) of the multi-view input image data 310 illustrated in FIG. 3 and the multi-view input image data 410 illustrated in FIG. 4. For example, the multi-view image data 510 can have a size or dimensions or (B, 6, 3, 352, 640), indicating that the multi-view image data 510 includes (e.g., at each time step represented in the multi-view image data 510) RGB image data captured by or associated with six different views/cameras, each RGB image data having three channels with pixel dimensions of 352×640.

In one illustrative example, the transformer-based machine learning network 500 can include a plurality of linear transformer (e.g., linformer) layers 534 (e.g., included in a plurality of attention layers 530) that are associated with a linear computational complexity O(n) with respect to input sequence length (e.g., input image resolution of the multi-view input image data 510). In some examples, the plurality of attention layers 530 can be the same as or similar to the one or more attention layers 330 illustrated in FIG. 3. A visual perception task output 550 can be the same as or similar to the visual perception task output 350 illustrated in FIG. 3 and/or the visual perception task output 450 illustrated in FIG. 4. In some aspects, the visual perception task output 550 illustrated in FIG. 5 can have a higher resolution than the visual perception task output 450 illustrated in FIG. 4 and/or the visual perception task output 350 illustrated in FIG. 3, based on using the linear transformer layers 534 to generate higher resolution feature maps for determining attention. In one illustrative example, the linear transformer layers 534 can determine attention (e.g., self-attention and/or cross-attention) for features generated from the multi-view input image data 510 using as input feature maps that have a greater resolution and a greater quantity of features than those associated with the MHSA layers 430 illustrated in FIG. 4.

For example, the linear transformer layers (e.g., linformer layers) 534 can receive as input feature maps having a spatial dimension of 22×40×6, which can include four times as many features (e.g., n=5280) as the quantity of features included in the input feature maps of spatial dimension 11×20×6 depicted in FIG. 4 (e.g., n=1320). In some aspects, the linear transformer layers 534 can determine an attention output associated with the input feature maps of spatial dimensions 22×40×6 with approximately the same computational complexity, time, and/or resources associated with using the MHSA layers 430 of FIG. 4 to determine an attention output associated with the input feature maps of spatial dimensions 11×20×6.

The multi-view input image data 510 can be provided as input to an image encoder 520, which in some aspects can be the same as or similar to the image encoder 420 illustrated in FIG. 4. For example, the image encoder 520 can generate an output a corresponding set of features or embeddings associated with the multi-view image data 510. In some cases, the image encoder 520 can be a CNN implementing a ResNet architecture (e.g., such as ResNet34, among others).

In one illustrative example, the transformer-based machine learning network 500 can include a plurality of attention layers 530 for determining an attention (e.g., self-attention, cross-attention) associated with the features generated by image encoder 520 using the multi-view image data 510 as input. In some aspects, the attention layers 530 can include or otherwise be used to implement a plurality of different scales. In some examples, the attention layers 530 can include or be used to implement five scales that are the same as or similar to the five scales illustrated in FIG. 4 and described above. For example, each scale included in the plurality of scales can receive as input a set of features having an increased quantity of channels relative to the three channels (e.g., RGB channels) included in the multi-view input image data 510 and having a decreased spatial or pixel resolution relative to that of the multi-view input image data 510. In some cases, the five scales included in attention layers 530 can receive as input from image encoder 520 a corresponding five feature sets (B, 6, C1, 176, 320), (B, 6, C2, 88, 160), . . . , (B, 6, C5, 11, 20) that are the same as the five feature sets generated by image encoder 420 and provided to the five scales included in the MHSA layers 430 illustrated in FIG. 4.

Each scale of the plurality of scales included in attention layers 530 can include one or more convolution (e.g., DS convolution) and flattening layers that generate as output a set of spatially reduced features based on the feature sets provided to each respective one of the scales. For example, the first scale included in attention layers 530 can include one or more convolution and flattening layers that receive as input (e.g., from image encoder 520) a feature set of (B, 6, C1, 176, 320) features and generate as output a set of high-resolution spatially reduced features (B, 22×40×6, C1), etc.

In one illustrative example, all but the last (e.g., smallest) scale included in the plurality of scales implemented by attention layers 530 can receive as input a high-resolution feature map (e.g., such as the high-resolution feature maps of size (B, 22×40×6, Ci) illustrated in FIG. 5). For example, the attention layers 530 include five scales, the first four of which are associated with the linear transformer layers 534 and utilize a high-resolution feature map of size (B, 22×40×6, Ci). The last (e.g., smallest) scale included in attention layers 530 includes an MHSA layer 536. In some cases, the MHSA layer 536 can be the same as the last (e.g., smallest) scale included in the MHSA attention layers 430 illustrated in FIG. 4. For example, the MHSA layer 536 (e.g., the last/fifth scale included in attention layers 530) can be implemented using an MHSA attention layer that receives as input a lower-resolution feature map of size (B, 11×20×6, C5).

In some aspects, a feature size associated with the four linformer attention layers included in the set of linear transformer layers 534 illustrated in FIG. 5 can be greater than the feature size associated with the MHSA layer 536. For example, each linear transformer layer included in the set of linear transformer layers 534 can include a high resolution 22×40×6 feature map that includes n_{linformer}=22*40*6=5280 features. The feature size associated with the relatively low resolution 11×20×6 feature maps provided to the MHSA layer 536 can be n_{MHSA}=11*20*6=1320 features.

In some aspects, the set of linear transformer layers 534 included in the attention layers 530 of FIG. 5 can be associated with a spatial dimension reduction. For example, a spatial dimension reduction can be applied for the first four scales included in or otherwise implemented by the attention layers 530. In some aspects, the spatial dimension reduction can be applied for each respective scale that is associated with a linear transformer layer (e.g., the first four scales illustrated in FIG. 5). In one illustrative example, the spatial dimension reduction can be a spatial dimension reduction of 2^{(L-2-i)}, where L represents the total quantity of scales and i represents the i-th scale. For example, the plurality of attention layers 530 includes five layers (e.g., L=5) and a spatial dimension reduction of 2⁽⁵⁻²⁻ⁱ⁾=2⁽³⁻ⁱ⁾ can be applied for each of the first four scales.

In one illustrative example, each linear transformer layer included in the set of linear transformer layers 534 can include one or more linformer layers or other linear complexity transformer and/or attention layers. In some aspects, each linear transformer layer (e.g., linformer layer) can be associated with a fixed feature map size k. For example, the four liner transformer layers 534 can each be associated with a fixed resolution k=2048. In one illustrative example, a linformer (e.g., or other linear attention layer and/or other linear attention transformer) can be used to determine self-attention (e.g., or cross-attention) in linear time and memory complexity with respect to input sequence length. For example, a linformer can use two linear projection matrices to determine the key and value inputs (e.g., the key and value inputs described previously above with respect to the transformer architecture).

In one illustrative example, the original key and value layers associated with a transformer may be (n×d)-dimensional. As illustrated in FIG. 5, the original key and value layers may be (5280×Ci)-dimensional, based on n=22*40*6=5280 and d=Ci. For example, the original key and value layers associated with the first scale of the plurality of attention layers 530 may be (5280×C1)-dimensional, the original key and value layers associated with the second scale of the plurality of attention layers 530 may be (5280×C2)-dimensional, etc.

Each liner transformer layer included in the plurality of liner transformer layers 534 can project the original (n×d)-dimensional key and value layers into (k×d)-dimensional projected key and value layers, respectively. For n>k, the linformer parameter k represents a fixed resolution reduction from the original feature size n. For example, as illustrated in FIG. 5, each liner transformer layers=included in the plurality of liner transformer layers 534 can implement a fixed resolution reduction from the original feature size of n=5280 to the fixed resolution k=2048. In some aspects, the (k×d)-dimensional projected key and value layers can be used to compute an (n×k)-dimensional context mapping matrix using scaled dot-product attention, which can subsequently be used to determine context embeddings for each head (e.g., each headᵢ) associated with a multi-headed self-attention. In some examples, the context embeddings can be determined in O(nk) time and space complexity. In some cases, for a small projected dimension k (e.g., such that k<<n), the memory and space consumption associated with determining attention can be significantly reduced such that the full O(n²) complexity attention determination can be approximated in linear, O(n) complexity in time and space.

In one illustrative example, the linear attention output determined by each linformer scale included in the plurality of liner transformer layers 534 can be provided to one or more deconvolution (e.g., DS deconvolution layers), in a manner the same as or similar to that described with respect to the DS deconvolution layers illustrated in FIG. 4. The decoder 540 can receive the output(s) of the DS deconvolution layer(s) and may be the same as or similar to the decoder 440 illustrated in FIG. 4. The decoder 540 can generate as output a plurality of visual perception task outputs 550 associated with the multi-view input image data 510 and a given visual perception task performed using the transformer-based machine learning network 500. For example, when the visual perception task is a depth estimation task, the decoder 540 can generate as output a plurality of depth maps as the visual perception task outputs 550 associated with the multi-view input image data 510 (e.g., one depth map output for each respective view included in the six views of multi-view input image data 510).

Based on using the plurality of linear transformer layers 534 (e.g., linformers), the systems and techniques can be used to provide higher-resolution attention for cross-view feature processing (e.g., cross-view feature processing for a visual perception task associated with the multi-view input image data 510). In some aspects, the plurality of linear transformer layers 534 (e.g., linformers) can be used to implement attention computation having an attention computation cost that is linear with respect to the input resolution (e.g., the input image resolution associated with the multi-view input image data 510). For example, the plurality of linear transformer layers 534 (e.g., linformers) can be used to determine attention using feature maps with a 2× size increase (e.g., a 4× increase in feature count, n) relative to existing O(n²) complexity attention, using an approximately equal computational complexity and/or computational resources as the existing O(n²) complexity attention computation. In some examples, based on computing attention using higher resolution feature maps for a given computational complexity, the systems and techniques can be used to determine the one or more visual perception task outputs 550 with improved accuracy. For example, higher resolution feature maps used for a depth estimation visual perception task can be associated with improved accuracy and/or reduced error in the resulting depth map output(s) 550.

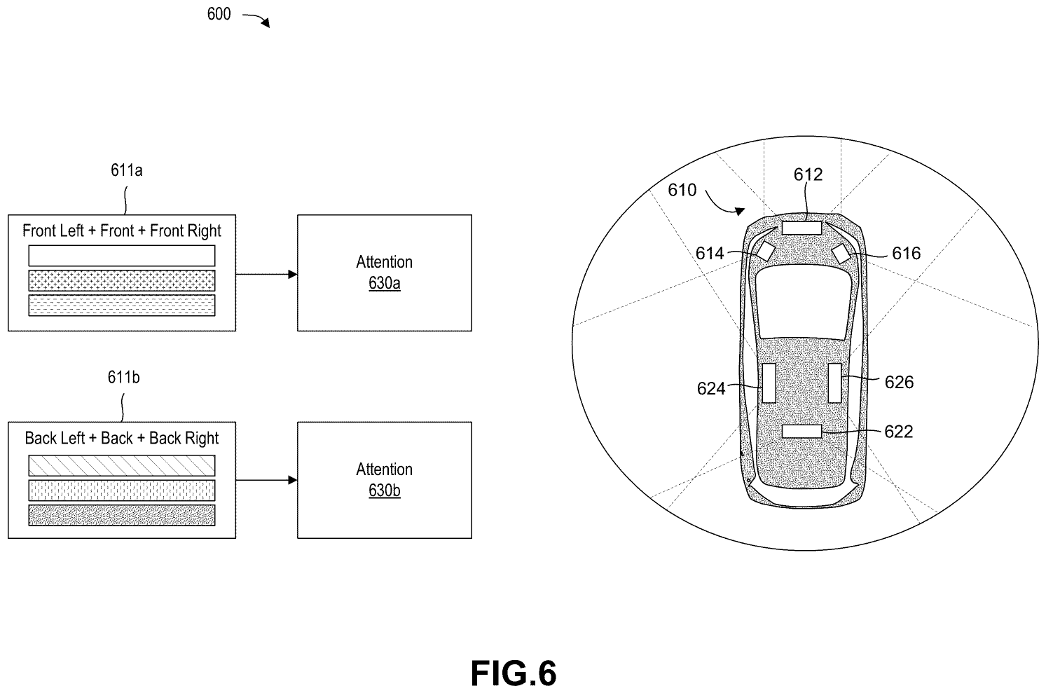

For example, FIG. 6 is a diagram illustrating an example view partitioning 600 that can be used to determine attention (e.g., cross-attention), including cross-view attention and/or self-attention for performing a machine learning-based visual perception task. In one illustrative example, a multi-view input image data (e.g., such as the multi-view input image data 310 illustrated in FIG. 3, the multi-view input image data 410 illustrated in FIG. 4, and/or the multi-view input image data 510 illustrated in FIG. 5) can be determined using a plurality of cameras 610 that are associated with a corresponding plurality of camera views (or spatial views). For example, the plurality of cameras 610 may be included on a vehicle, XR or AR headset, smartphone or other mobile computing device, IoT device and/or IoT camera network, etc.

As illustrated, the plurality of cameras 610 may be associated with fixed relative positions relative to one another. For example, the plurality of cameras 610 can include a front camera 612, a front left camera 614, a front right camera 616, a back left camera 624, a back right camera 626, and a back camera 622. In some aspects, the plurality of cameras 610 can include one or more sets or groups of cameras that each capture a view that is at least partially overlapping with some (or all) of the respective views captured by the remaining cameras included in the same group.

For example, the respective spatial views captured by the plurality of cameras 610 can be partitioned into a first group of partially overlapping views 611a and a second group of partially overlapping views 611b. In some examples, the first group of partially overlapping views 611a can include the front camera view 612, the front left camera view 614, and the front right camera view 616. In some examples, the second group of partially overlapping views 611b can include the back camera view 622, the back left camera view 624, and the back right camera view 626.

In one illustrative example, each group of overlapping camera views (e.g., the first and second groups of partially overlapping camera views 611a, 611b) can include a unique set of individual camera views. For example, in some cases, each given camera view included in the plurality of camera views from the camera 610 is included in up to one group of overlapping camera views (e.g., a given camera view is not included in multiple groups of overlapping camera views). In some examples, a given camera view may be included in two more different groups of overlapping camera views.

In some aspects, some (or all) of the groups of overlapping camera views (e.g., such as the first and second groups of overlapping camera views 611a, 611b, respectively) may be non-overlapping with some (or all) of the remaining groups of overlapping camera views. For example, the first group of overlapping camera views 611a may have zero overlap with the second group of overlapping camera views 611b (e.g., the front left camera view 614 and the back left camera view 624 may be non-overlapping, and the front right camera view 616 and the back right camera view 626 may be non-overlapping).

In some examples, some (or all) of the groups of overlapping camera views may be at least partially overlapping with some (or all) of the remaining groups of overlapping camera views. For example, the first group of overlapping camera views 611a may include one or more camera views that have at least a partial overlap with one or more camera views included in the second group of overlapping camera views 611b. In one illustrative example, the front left camera view 614 included in the first group of overlapping camera views 611a may at least partially overlap with the back left camera view 624 included in the second group of overlapping camera views 611b. Additionally, or alternatively, the front right camera view 616 included in the first group of overlapping camera views 611a may at least partially overlap with the back right camera view 626 included in the second group of overlapping camera views 611b.

In some aspects, various different view partitions can be utilized for a given set of multiple cameras and/or multiple camera views (e.g., such as the plurality of cameras/camera views 610). For example, a first group of partially overlapping camera views may include the front camera view 612 and the front left camera view 614, a second group of partially overlapping camera views may include the back left camera view 624 and the back camera view 622, and a third group of partially overlapping camera views may include the back right camera view 626 and the front right camera view 616; etc. In one illustrative example, the view partitioning of multiple camera views (e.g., included in a multi-view input image data) can be performed for a multi-view input image data that includes multiple views over time. For example, view partitioning can be performed to generate one or more groups of at least partially overlapping camera views wherein each group includes multiple camera views each captured at different points in time and including at least a partial overlap with one or more (or all) of the remaining multiple camera views included in the same group.

In one illustrative example, each group of at least partially overlapping camera views (e.g., such as groups 611a, 611b) can be provided as input to a separate attention engine. For example, the first group of partially overlapping camera views 611a can be provided to a first set of one or more attention layers 630a and the second group of partially overlapping camera views 611b can be provided to a second set of one or more attention layers 630b. The first and second sets of attention layers 630a, 630b, respectively, can be the same or similar. In some cases, the first and second sets of attention layers 630a, 630b, respectively, can be different from one another.

In one illustrative example, the first set of attention layers 630a and the second set of attention layers 630b can be the same as or similar to the one or more attention layers 330 illustrated in FIG. 3. In another illustrative example, the first set of attention layers 630a and the second set of attention layers 630b can be the same as or similar to the plurality of MHSA layers 430 illustrated in FIG. 4. In another illustrative example, the first set of attention layers 630a and the second set of attention layers 630b can be the same as or similar to the plurality of attention layers 530 and/or the plurality of linear transformer layers 534 illustrated in FIG. 5.

In some aspects, the view partitioning of a given set of multiple cameras and/or multiple camera views included in a multi-view input image data (e.g., such as the plurality of cameras/camera views 610 illustrated in FIG. 6) can be pre-determined. For example, the view partitioning can be pre-determined based on an offline analysis of a relative physical or spatial positioning of each camera included in the plurality of cameras 610. In some examples, the view partitioning can be determined dynamically, for example based on one or more inputs indicative of camera intrinsic information and/or indicative of a relative physical or spatial positioning of each camera included in the plurality of cameras 610. In some cases, the systems and techniques can perform an image content analysis of the different camera views included in a multi-view input image data to determine one or more sets of camera views that are at least partially overlapping with one another. Based on the image content analysis and/or identified sets of camera views that are at least partially overlapping, the systems and techniques can generate the view partitioning of two or more sets of at least partially overlapping camera views and provide each respective set of at least partially overlapping camera views to a corresponding one or more attention layers for performing one or more visual perception tasks.

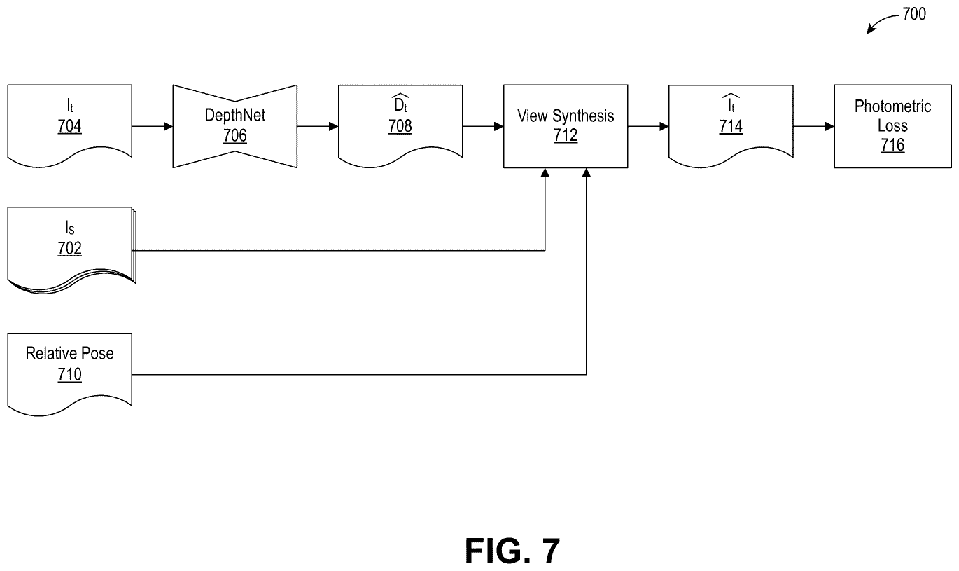

For example, FIG. 7 is a block diagram of a self-supervised vision system 700 configured to determine a depth using structure-from-motion principles. In the case of a single camera, collecting dense high-quality depth annotation information (e.g., from a LiDAR) is not possible. For example, measurements from LiDAR are sparse and noisy and the noise is exacerbated in a multi-image sensor configuration. In this case, a device can use structure-from-motion principles to generate a depth map and determine photometric loss.

Structure-from-motion uses a plurality of images. For instance, as shown in FIG. 7, the self-supervised vision system 700 receives source images 702 and a target image 704. The target image 704 is temporally between the source images 702. A depth of the target image 704 is determined using a depth network 706. For example, the depth network 706 can generate depth predictions 708 from the target images 704. The depth predictions 708 and a relative pose 710 of the self-supervised vision system 700 are provided to a view synthesis engine 712. The view synthesis engine 712 can generate a reconstructed target image 714 based on a source image 702, the depth predictions 708, and the relative pose 710. The reconstructed target image 714 is a synthesized or reconstructed version of the target image Iₜ (shown in FIG. 7 as Îₜ). A photometric loss 716 can be determined by comparing the target image 704 and the reconstructed target image 714 (e.g., by determining a difference between the target image 704 and the reconstructed target image 714). The photometric loss 716 can be used as a system objective to optimize the self-supervised vision system 700 (e.g., tune parameters, such as weights, of the self-supervised vision system 700, such as of the depth network 706 and/or the view synthesis engine 712).

The self-supervised vision system 700 eliminates the need for a ground truth and the abundance of image sequences from each camera provides sufficient data for the self-supervised vision system 700. However, the self-supervised vision system 700 cannot be implemented in a multi-image system due to parasitics and various effects described above. For example, in a multi-image system such as an autonomous vehicle, the image sensors of the self-supervised vision system 700 may have time differences due to different exposure times of the different image sensors.

Various aspects are proposed to improve multi-image systems. In some aspects, a generative model is configured to generate the intermediary camera frames. For example, a generative model may be a generative adversarial network (GAN), which is used to generate content that is not present based on training. In one aspect, based on providing a plurality of frames from an image sensor, a generative model such as a GAN can be used to generate an image from the image sensor based on previous images. In one aspect, the generative model can identify and generate predicted images for a plurality of image sensors at a specific point in time. In this case, the predicted images align the features in time and may be provided to a depth estimation network to identify depth of features.

In some aspects, timing information of a plurality of input images may be provided in a machine learning network. In this case, the timing information can be combined with a corresponding image or features of the corresponding image to align the features in time. The features are aligned in time and can be provided to a depth estimation network to identify the depths of features in the plurality of input images.

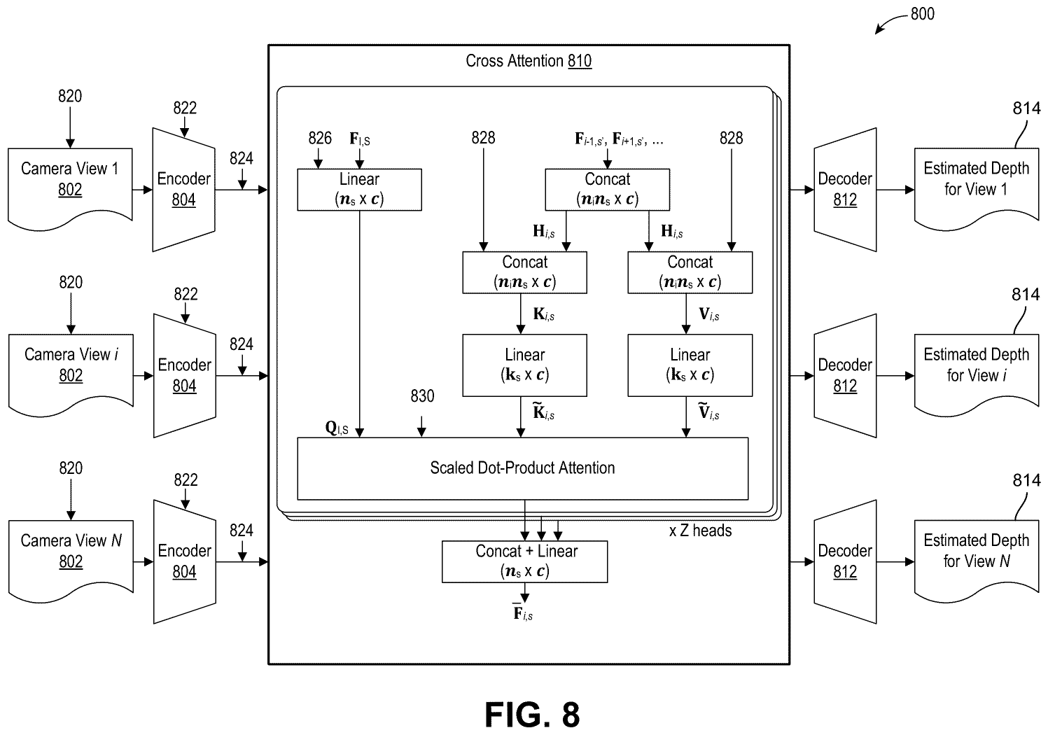

FIG. 8 is a block diagram of a self-supervised vision system 800 configured to align features of multiple observations in time in accordance with some aspects of the disclosure. In one illustrative aspect, the self-supervised vision system 800 is configured to perform one or more perception-related tasks, such as determining a depth of features associated with one or more input images 802.

In one aspect, the self-supervised vision system 800 includes encoders 804, an attention engine 810, and decoders 812 that generate depth maps 814 associated with each image 802. In one example, the attention engine 810 can generate a set of projected features based on the set of features and determine a cross-view attention associated with the plurality of different spatial views. In this example, an embedding size associated with the set of projected features is smaller than an embedding size associated with the set of features and the cross-view attention determined using the set of projected features. For example, the self-supervised vision system 800 can generate depth maps 814 based on input images.

As noted above, there can be time differences associated with each image, which would affect various operations such as object identification, synthesizing features of each image 802, and so forth.

In some aspects, time information can be combined using the self-supervised vision system 800 to synchronize the features in the images 802. In some aspects, there is a trade-off between computational overhead, data replication, and complexity based on how time information is provided into the self-supervised vision system 800. For example, integrating timing information earlier into the self-supervised vision system 800 has lower design complexity but increases computation overhead. For example, adding the timing information to feature information provided by an encoder required 3D convolutions to fuse the channels. In another example, adding the timing information to the images 802 is simpler and can be implemented by concatenating the channels. In some aspects, more overhead is introduced based on more computations, higher memory consumption, and so forth. Delaying integration of the timing information creates more complexity but reduces memory consumption, computations, and increases efficiency.

In some aspects, FIG. 8 illustrates different aspects in which timing information can be combined into the self-supervised vision system 800. In one aspect, at reference label 820, the self-supervised vision system 800 may combine the timing information of each image with the images 802 before encoding. In one example, a tensor can be combined with the image 802. In another example, the channels of the image 802 can be concatenated and time information of features can be added. In each case, the number of floats added to the image 802 is premised on the size of the image. This case adds millions of floats to be computed in the encoder. For example, a tensor containing B*k*H*W 32-bit floats added, where H is the height in pixels, W is width in pixels, and k is the number of images 802.

In another aspect of combining the timing information, at reference label 822, the self-supervised vision system 800 may combine the timing information to features to multi-scale features in the encoder 804 before downsampling. For example, a tensor having B*k*h*w 32-bit floats is added.

In another aspect of combining the timing information, at reference label 824, the self-supervised vision system 800 may combine the timing information to downscaled multi-scale features from the encoder 804. In this case, the encoder 804 encodes features B, C, h, and w, with h being the downsampled height and w being the downsampled width. For example, the timing information can be combined with the downscaled multi-scale features using 3D convolutions to fuse the channels.

In another aspect of combining the timing information, at reference label 826, the self-supervised vision system 800 may combine the timing information with flattening features provided in the downsampled multi-scale features. For example, the timing information can be combined with the flattening features using 1D convolutions. In this case, the number of 32-bit floats added to the tensor is in the order of thousands.

In another aspect of combining the timing information, at reference label 828, the self-supervised vision system 800 may combine the timing information with the keys and values generated in the attention engine 810. For example, the attention engine 810 can generate keys, queries, and values using the downsampled multi-scale features from the encoder 804, and the self-supervised vision system 800 can attach the timing information in a tensor before linear projection.

In another aspect of combining the timing information, at reference label 830, the self-supervised vision system 800 may combine the timing information with the queries generated in the attention engine 810. For example, the attention engine 810 can generate keys, queries, and values using the downsampled multi-scale features from the encoder 804 and attach the timing information to the queries before dot-product attention is computed.

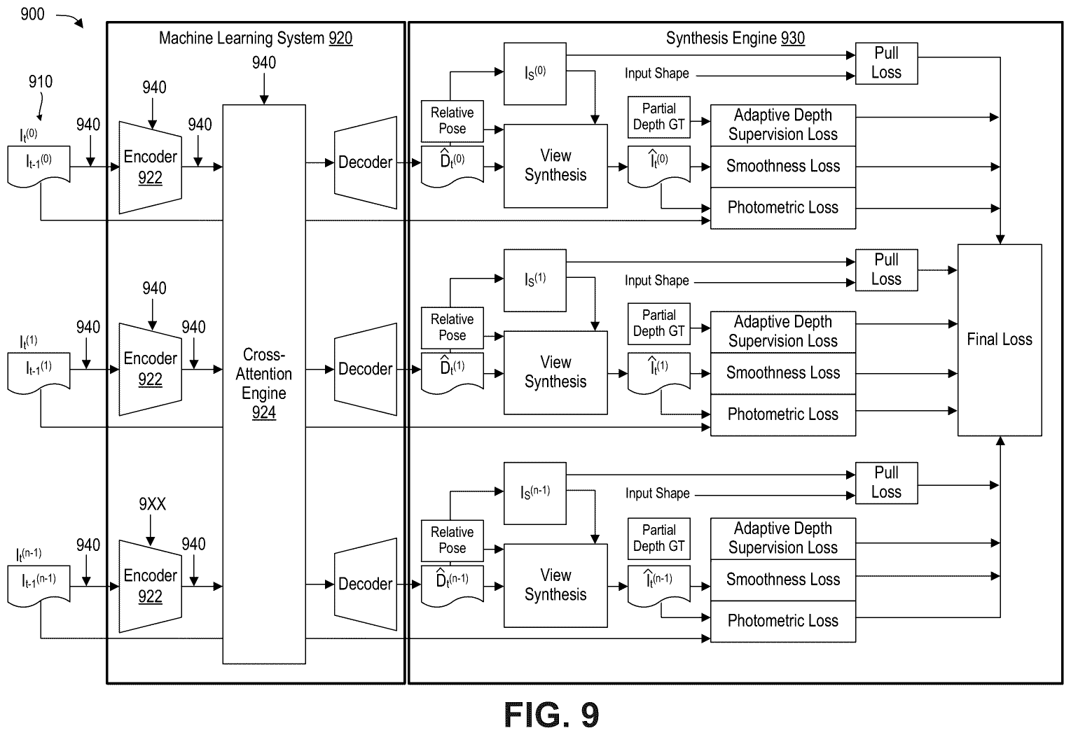

FIG. 9 is a detailed block diagram of a self-supervised vision system 900 that uses structure-from-motion principles and timing synchronization in accordance with some aspects of the disclosure.

In one aspect, the self-supervised vision system 900 includes a plurality of image sensors (not shown) that generate images 910 that are used to generate features in a machine learning system 920, and a synthesis engine 930 to determine a set of features from the different images. In one illustrative aspect, the machine learning system 920 is configured to use time information 940 of each image 910 and combine the time information 940 into the features to align the features in time. In some examples, the time information 940 can be combined with each image prior to encoding being performed by an encoder 922 of the machine learning system 920. Additionally or alternatively, in some examples, the time information 940 can be combined with the encoding process by providing the time information 940 to the encoder 922. Additionally or alternatively, in some examples, the time information 940 can also be combined with the encoded result of the encoder 922 before input into the cross-attention engine 924 (e.g., the self-supervised vision system 800 of FIG. 8) of the machine learning system 920. Additionally or alternatively, in some examples, the time information 940 can be combined at different stages of the cross-attention engine 924 (e.g., as shown in FIG. 8).

In some aspects, the synthesis engine 930 may use the synchronized feature information to determine a photometric loss, a smoothness loss, an adaptive depth supervision loss, and a pull loss associated with each image. The photometric loss, a smoothness loss, an adaptive depth supervision loss, and a pull loss for each image are converted into a final loss. In some aspects, the final loss can be used to backpropagate while training a machine learning model. For example, the final loss can be used to train a depth estimation network (e.g., depth network 706) that receives the feature information and generates a depth map.

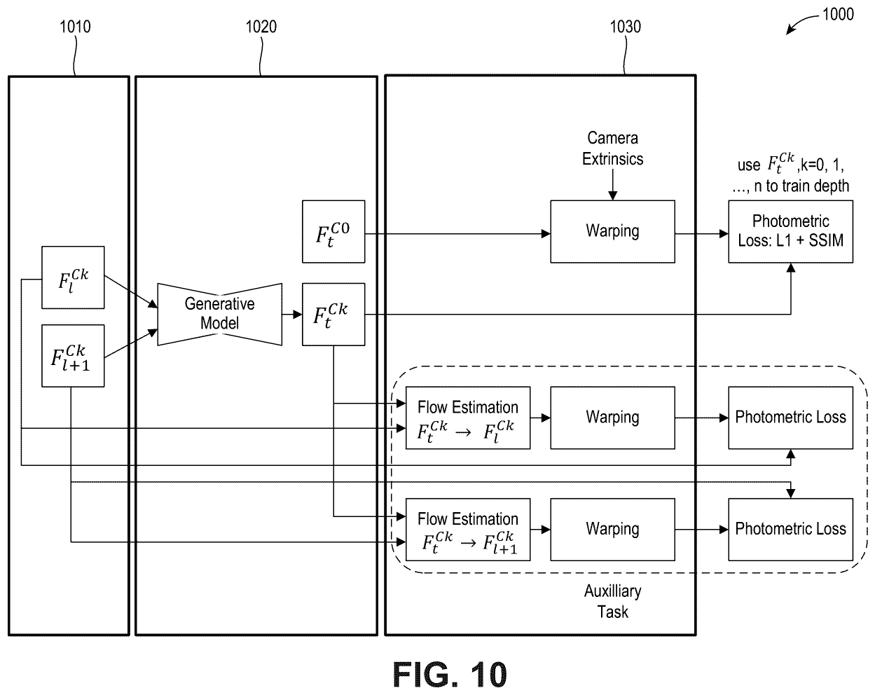

FIG. 10 is a block diagram of a self-supervised vision system 1000 configured to align features of multiple images in time in accordance with some aspects of the disclosure. In some aspect, the self-supervised vision system 1000 is configured to receive a plurality of images 1010 from a plurality of image sensors, generate images using a generative model 1020, and perform depth estimation in a depth estimation network (not shown). In this case, the self-supervised vision system 1000 also can access previous images in sequence to generate images as further described below.

In some aspects, the generative model 1020 receives a reference image (e.g., reference image (Fₜ^{C0}) from the main camera C0 at time t and generates the corresponding frames for the other cameras Ck at time t. For example, the reference image Fₜ^{Ck} from camera Ck is selected and a subsequent image Fₗ₊₁^{Ck} is selected to comport with T(l)≤t<T(l+1), l∈N. In this case, T is the timestamp corresponding to a frame index, and the images and tuple (T(l), T(l+1), and t) are provided to the generative model 1020 to generate frame Fₜ^{Ck} at time t.

In another aspect, reference image Fₗ^{Ck}, the subsequent image Fₗ₊₁^{Ck}, and

$$\frac{t - T ( l )}{T ( l + I ) - T ( l )}$$

are provided to the generative model 1020 to find an image between the scale value.

The generated images are from the generative model 1020 are provided to a depth estimation network (e.g, the synthesis engine 930) to synthesize features in the various images.

In some aspects, FIG. 10 conceptually illustrates a training system 1030 configured to train the generative model 1020. In one aspect, the training system 1030 performs an optical flow estimation based on the generated image and reference images form the camera. The generated images are warped based on the optical flow, and then a photometric loss is determined based on the reference images from the camera. For example, the reference image Fₗ^{Ck} is compared to the generated frame Fₜ^{Ck} and a photometric loss is computed. In some cases, the photometric loss guides the whole system to generate more realistic and higher quality samples.

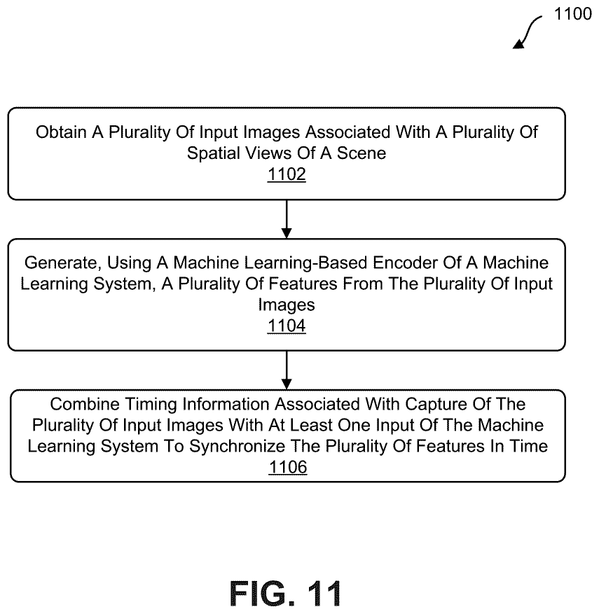

FIG. 11 is a flowchart illustrating an example method 1100 for processing images in accordance with aspects of the present disclosure. The method 1100 can be performed by a computing device having an image sensor, such as a mobile wireless communication device, an AV, a CV robot function (e.g., manufacturing), a camera, an XR device, a wireless-enabled vehicle, or another computing device. In one illustrative example, a computing system 1400 can be configured to perform all or part of the method 1100. In one illustrative example, an ISP such as the ISP 154 can be configured to perform all or part of the method.

At block 1102, the computing system (e.g., the computing system 1300) is configured to obtain a plurality of input images associated with a plurality of spatial views of a scene. In some aspects, the computing system includes a plurality of each image sensors, and each image sensor is configured to capture the plurality of input images is triggered at a first time. In some cases, a first input image of the plurality of input images is output from a first image sensor at a different time than a second input image of the plurality of input images is output from a second image sensor. For example, each image sensor may have individual parasitics and other parameters (e.g., exposure time) that cause each image from the image sensors to be output at different times.

At block 1104, the computing system (e.g., the computing system 1300) is configured to generate, using a machine learning-based encoder of a machine learning system, a plurality of features from the plurality of input images.

At block 1106, the computing system (e.g., the computing system 1300) is configured to combine timing information associated with capture of the plurality of input images with at least one input of the machine learning system to synchronize the plurality of features in time. In some aspects, the at least one input comprises at least one input image of the plurality of input images and combining the timing information associated with capture of the plurality of input images with the at least one input of the machine learning system.

In one aspect, the at least one input comprises multi-scale feature information generated from the at least one input image using the machine learning-based encoder. In this case, combining the timing information associated with capture of the plurality of input images with the at least one input of the machine learning system comprises adding the timing information to the multi-scale feature information.

In another aspect, the at least one input comprises downscaled multi-scale feature information generated from the at least one input image using the machine learning-based encoder. In this case, combining the timing information associated with capture of the plurality of input images comprises adding the timing information to the downscaled multi-scale feature information.

In another aspect, the at least one input comprises flattening features associated with multi-scale feature information generated from the at least one input image using the machine learning-based encoder. In this case, combining the timing information associated with capture of the plurality of input images comprises adding the timing information to the flattening features.

In another aspect, the at least one input comprises keys and values generated from multi-scale feature information using the machine learning-based encoder. In this case, combining the timing information associated with capture of the plurality of input images comprises adding the timing information to the keys and the values before linearization of the keys and the values.

In another aspect, the at least one input comprises queries generated from multi-scale feature information using the machine learning-based encoder. In this case, combining the timing information associated with capture of the plurality of input images comprises adding the timing information to the queries before determining an attention using the queries.

In some aspects, the computing system may determine a cross-view attention between the plurality of spatial views based on the plurality of features generated from the plurality of input images associated with the plurality of spatial views and determine depth associated with the plurality of input images based on the cross-view attention.

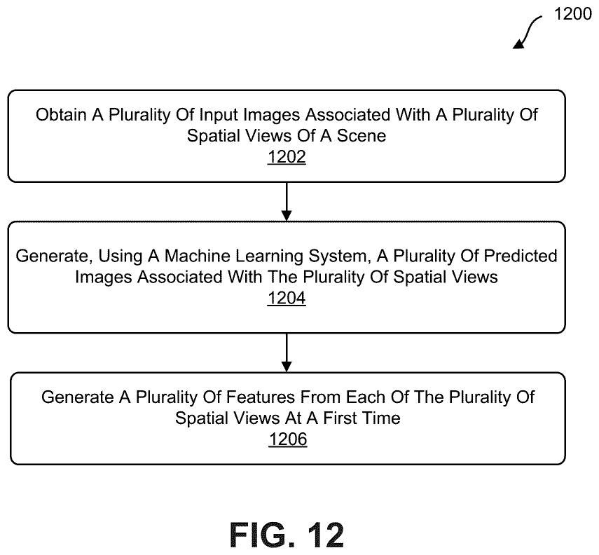

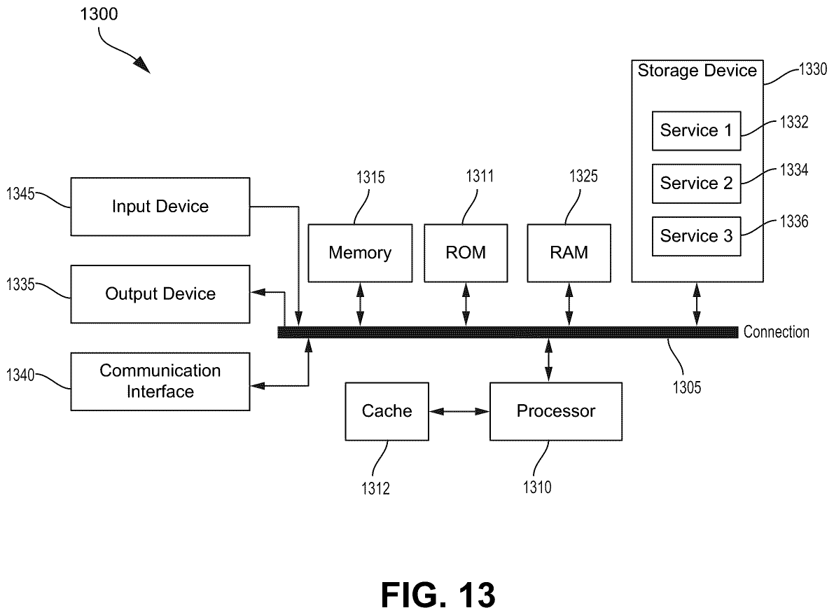

FIG. 12 is a flowchart illustrating an example process 1200 for processing images in accordance with aspects of the present disclosure. The process 1200 can be performed by a computing device (or apparatus) or a component (e.g., a chipset, codec, etc.) of the computing device. The computing device may be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device. The operations of the process 1200 may be implemented as software components that are executed and run on one or more processors (e.g., CPU 102, GPU 104, DSP 106, and/or NPU 108 of FIG. 1A, the processor 1310 of FIG. 13, or other processor(s)). Further, the transmission and reception of signals by the computing device in the process 1200 may be enabled, for example, by one or more antennas, one or more transceivers (e.g., wireless transceiver(s)), and/or other communication components of the computing device.

At block 1202, the computing device (or component thereof) can obtain a plurality of input images associated with a plurality of spatial views of a scene. In some aspects, the computing system includes a plurality of each image sensors, and each image sensor is configured to capture the plurality of input images is triggered at a first time. In some cases, a first input image of the plurality of input images is output from a first image sensor at a different time than a second input image of the plurality of input images is output from a second image sensor. For example, each image sensor may have individual parasitics and other parameters (e.g., exposure time) that cause each image from the image sensors to be output at different times.

At block 1204, the computing device (or component thereof) can generate, using a machine learning system, a plurality of predicted images associated with the plurality of spatial views. In some aspects, each of the plurality of predicted images are each generated to correspond to an of estimate the plurality of features at the first time.

At block 1206, the computing device (or component thereof) can generate a plurality of features from each of the plurality of spatial views at a first time.

In some aspects, the computing device (or component thereof) can warp each image from the plurality of predicted images based on extrinsic information (e.g., extrinsic parameters) of a corresponding image sensor. For example, in a multi-image sensor autonomous vehicle, a position of the each camera is known and the images can be warped based on their known position to create an aligned representation of the predicted images.

In some aspects, the computing device (or component thereof) can determine a cross-view attention between the plurality of spatial views based on the plurality of features generated from the plurality of input images associated with the plurality of spatial views and determine depth associated with the plurality of input images based on the cross-view attention.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1200 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1200 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a diagram illustrating an example of a system for implementing certain aspects of the present technology. In particular, FIG. 13 illustrates an example of computing system 1300, which may be for example any computing device making up internal computing system, a remote computing system, a camera, or any component thereof in which the components of the system are in communication with each other using connection 1305. Connection 1305 may be a physical connection using a bus, or a direct connection into processor 1310, such as in a chipset architecture. Connection 1305 may also be a virtual connection, networked connection, or logical connection.

In some embodiments, computing system 1300 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 may include a cache 1312 of high-speed memory connected directly with, in close proximity to, or integrated as part of processor 1310.

Processor 1310 may include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which may represent any number of input mechanisms, such as a microphone for speech, a touch-sensitive screen for gesture or graphical input, keyboard, mouse, motion input, speech, etc. Computing system 1300 may also include output device 1335, which may be one or more of a number of output mechanisms. In some instances, multimodal systems may enable a user to provide multiple types of input/output to communicate with computing system 1300.

Computing system 1300 may include communications interface 1340, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 may include software services, servers, services, etc., that when the code that defines such software is executed by the processor 1310, it causes the system to perform a function. In some embodiments, a hardware service that performs a particular function may include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A method for processing image data, comprising: obtaining a plurality of input images associated with a plurality of spatial views of a scene; generating, using a machine learning-based encoder of a machine learning system, a plurality of features from the plurality of input images; and combining timing information associated with capture of the plurality of input images with at least one input of the machine learning system to synchronize the plurality of features in time.
Aspect 2. The method of Aspect 1, wherein each image sensor is configured to capture the plurality of input images is triggered at a first time.
Aspect 3. The method of any of Aspects 1 or 2, wherein a first input image of the plurality of input images is output from a first image sensor at a different time than a second input image of the plurality of input images is output from a second image sensor.
Aspect 4. The method of any of Aspects 1 to 3, wherein the at least one input comprises at least one input image of the plurality of input images, and wherein combining the timing information associated with capture of the plurality of input images with the at least one input of the machine learning system comprises combining the timing information with the at least one input image.
Aspect 5. The method of any of Aspects 1 to 4, wherein the at least one input comprises multi-scale feature information generated from at least one input image using the machine learning-based encoder, and wherein combining the timing information associated with capture of the plurality of input images with the at least one input of the machine learning system comprises adding the timing information to the multi-scale feature information.
Aspect 6. The method of any of Aspects 1 to 5, wherein the at least one input comprises downscaled multi-scale feature information generated from at least one input image using the machine learning-based encoder, and wherein combining the timing information associated with capture of the plurality of input images comprises adding the timing information to the downscaled multi-scale feature information.
Aspect 7. The method of any of Aspects 1 to 6, wherein the at least one input comprises flattening features associated with multi-scale feature information generated from at least one input image using the machine learning-based encoder, and wherein combining the timing information associated with capture of the plurality of input images comprises adding the timing information to the flattening features.
Aspect 8. The method of any of Aspects 1 to 7, wherein the at least one input comprises keys and values generated from multi-scale feature information using the machine learning-based encoder, and wherein combining the timing information associated with capture of the plurality of input images comprises adding the timing information to the keys and the values before linearization of the keys and the values.
Aspect 9. The method of any of Aspects 1 to 8, wherein the at least one input comprises queries generated from multi-scale feature information using the machine learning-based encoder, and wherein combining the timing information associated with capture of the plurality of input images comprises adding the timing information to the queries before determining an attention using the queries.
Aspect 10. The method of any of Aspects 1 to 9, further comprising: determining a cross-view attention between the plurality of spatial views based on the plurality of features generated from the plurality of input images associated with the plurality of spatial views; and determining depth associated with the plurality of input images based on the cross-view attention.
Aspect 11. A method for processing image data, comprising: obtaining a plurality of input images associated with a plurality of spatial views of a scene; generating, using a machine learning system, a plurality of predicted images associated with the plurality of spatial views; and generating a plurality of features from each of the plurality of spatial views at a first time.
Aspect 12. The method of Aspect 11, further comprising: warping each image from the plurality of predicted images based on extrinsic information of a corresponding image sensor.
Aspect 13. The method of any of Aspects 11 or 12, wherein each of the plurality of predicted images is generated to correspond to an of estimate the plurality of features at the first time.
Aspect 14. The method of any of Aspects 11 to 13, further comprising: determining a cross-view attention between the plurality of spatial views based on the plurality of features generated from the plurality of predicted images associated with the plurality of spatial views; and determining depth associated with the plurality of predicted images based on the cross-view attention.
Aspect 15. An apparatus for processing image data including at least one memory and at least one processor (e.g., implemented in circuitry) coupled to the at least memory and configured to: obtain a plurality of input images associated with a plurality of spatial views of a scene; generate, using a machine learning-based encoder of a machine learning system, a plurality of features from the plurality of input images; and combine timing information associated with capture of the plurality of input images with at least one input of the machine learning system to synchronize the plurality of features in time.
Aspect 16. The apparatus of Aspect 15, wherein each image sensor is configured to capture the plurality of input images is triggered at a first time.
Aspect 17. The apparatus of any of Aspects 15 to 16, wherein a first input image of the plurality of input images is output from a first image sensor at a different time than a second input image of the plurality of input images is output from a second image sensor.
Aspect 18. The apparatus of any of Aspects 15 to 17, wherein the at least one input comprises at least one input image of the plurality of input images, and wherein to combine the timing information associated with capture of the plurality of input images with the at least one input of the machine learning system, the at least one processor is configured to combine the timing information with the at least one input image.
Aspect 19. The apparatus of any one of Aspects 15 to 18, wherein the at least one input comprises multi-scale feature information generated from at least one input image using the machine learning-based encoder, and wherein to combine the timing information associated with capture of the plurality of input images with the at least one input of the machine learning system, the at least one processor is configured to add the timing information to the multi-scale feature information.
Aspect 20. The apparatus of any of Aspects 15 to 19, wherein the at least one input comprises downscaled multi-scale feature information generated from at least one input image using the machine learning-based encoder, and wherein to combine the timing information associated with capture of the plurality of input images, the at least one processor is configured to add the timing information to the downscaled multi-scale feature information.
Aspect 21. The apparatus of any of Aspects 15 to 20, wherein the at least one input comprises flattening features associated with multi-scale feature information generated from at least one input image using the machine learning-based encoder, and wherein to combine the timing information associated with capture of the plurality of input images, the at least one processor is configured to add the timing information to the flattening features.
Aspect 22. The apparatus of any of Aspects 15 to 21, wherein the at least one input comprises keys and values generated from multi-scale feature information using the machine learning-based encoder, and wherein to combine the timing information associated with capture of the plurality of input images, the at least one processor is configured to add the timing information to the keys and the values before linearization of the keys and the values.
Aspect 23. The apparatus of any of Aspects 15 to 22, wherein the at least one input comprises queries generated from multi-scale feature information using the machine learning-based encoder, and wherein to combine the timing information associated with capture of the plurality of input images, the at least one processor is configured to add the timing information to the queries before determining an attention using the queries.
Aspect 24. The apparatus of any of Aspects 15 to 23, wherein the at least one processor is configured to: determine a cross-view attention between the plurality of spatial views based on the plurality of features generated from the plurality of input images associated with the plurality of spatial views; and determine depth associated with the plurality of input images based on the cross-view attention.
Aspect 25. An apparatus for processing image data including at least one memory and at least one processor (e.g., implemented in circuitry) coupled to the at least memory and configured to: obtain a plurality of input images associated with a plurality of spatial views of a scene; generate, using a machine learning system, a plurality of predicted images associated with the plurality of spatial views; and generate a plurality of features from each of the plurality of spatial views at a first time.
Aspect 26. The apparatus of Aspect 25, wherein the at least one processor is configured to: warp each image from the plurality of predicted images based on extrinsic information of a corresponding image sensor.
Aspect 27. The apparatus of any of Aspects 25 to 26, wherein each of the plurality of predicted images is generated to correspond to an of estimate the plurality of features at the first time.
Aspect 28. The apparatus of any of Aspects 25 to 27, wherein the at least one processor is configured to: determine a cross-view attention between the plurality of spatial views based on the plurality of features generated from the plurality of predicted images associated with the plurality of spatial views; and determine depth associated with the plurality of predicted images based on the cross-view attention.
Aspect 29. A non-transitory computer-readable storage medium comprising instructions stored thereon which, when executed by at least one processor, causes the at least one processor to perform operations according to any of Aspects 1 to 10.
Aspect 30. An apparatus for wireless communications comprising one or more means for performing operations according to any of Aspects 1 to 10.
Aspect 31. A non-transitory computer-readable storage medium comprising instructions stored thereon which, when executed by at least one processor, causes the at least one processor to perform operations according to any of Aspects 11 to 14.
Aspect 32. An apparatus for wireless communications comprising one or more means for performing operations according to any of Aspects 11 to 14.

What is claimed is:

1. An apparatus for processing image data, the apparatus comprising:
at least one memory; and
at least one processor coupled to the at least one memory and configured to:
obtain a plurality of input images associated with a plurality of spatial views of a scene;
generate, using a machine learning-based encoder of a machine learning system, a plurality of features from the plurality of input images; and
combine timing information associated with capture of the plurality of input images with at least one input of the machine learning system to synchronize the plurality of features in time.

2. The apparatus of claim 1, wherein each image sensor is configured to capture the plurality of input images is triggered at a first time.

3. The apparatus of claim 1, wherein a first input image of the plurality of input images is output from a first image sensor at a different time than a second input image of the plurality of input images is output from a second image sensor.

4. The apparatus of claim 1, wherein the at least one input comprises at least one input image of the plurality of input images, and wherein to combine the timing information associated with capture of the plurality of input images with the at least one input of the machine learning system, the at least one processor is configured to combine the timing information with the at least one input image.

5. The apparatus of claim 1, wherein the at least one input comprises multi-scale feature information generated from at least one input image of the plurality of input images using the machine learning-based encoder, and wherein to combine the timing information associated with capture of the plurality of input images with the at least one input of the machine learning system, the at least one processor is configured to add the timing information to the multi-scale feature information.

6. The apparatus of claim 1, wherein the at least one input comprises downscaled multi-scale feature information generated from at least one input image of the plurality of input images using the machine learning-based encoder, and wherein to combine the timing information associated with capture of the plurality of input images, the at least one processor is configured to add the timing information to the downscaled multi-scale feature information.

7. The apparatus of claim 1, wherein the at least one input comprises flattening features associated with multi-scale feature information generated from at least one input image of the plurality of input images using the machine learning-based encoder, and wherein to combine the timing information associated with capture of the plurality of input images, the at least one processor is configured to add the timing information to the flattening features.

8. The apparatus of claim 1, wherein the at least one input comprises keys and values generated from multi-scale feature information using the machine learning-based encoder, and wherein to combine the timing information associated with capture of the plurality of input images, the at least one processor is configured to add the timing information to the keys and the values before linearization of the keys and the values.

9. The apparatus of claim 1, wherein the at least one input comprises queries generated from multi-scale feature information using the machine learning-based encoder, and wherein to combine the timing information associated with capture of the plurality of input images, the at least one processor is configured to add the timing information to the queries before determining an attention using the queries.

10. The apparatus of claim 1, wherein the at least one processor is configured to:
determine a cross-view attention between the plurality of spatial views based on the plurality of features generated from the plurality of input images associated with the plurality of spatial views; and
determine depth associated with the plurality of input images based on the cross-view attention.

11. A method for processing image data, the method comprising:
obtaining a plurality of input images associated with a plurality of spatial views of a scene;
generating, using a machine learning-based encoder of a machine learning system, a plurality of features from the plurality of input images; and
combining timing information associated with capture of the plurality of input images with at least one input of the machine learning system to synchronize the plurality of features in time.

12. The method of claim 11, wherein each image sensor is configured to capture the plurality of input images is triggered at a first time.

13. The method of claim 11, wherein a first input image of the plurality of input images is output from a first image sensor at a different time than a second input image of the plurality of input images is output from a second image sensor.

14. The method of claim 11, wherein the at least one input comprises at least one input image of the plurality of input images, and wherein combining the timing information associated with capture of the plurality of input images with the at least one input of the machine learning system comprises combining the timing information with the at least one input image.

15. The method of claim 11, wherein the at least one input comprises at least one of;
multi-scale feature information generated from at least one input image of the plurality of input images using the machine learning-based encoder, and wherein combining the timing information associated with capture of the plurality of input images with the at least one input of the machine learning system comprises adding the timing information to the multi-scale feature information;
downscaled multi-scale feature information generated from at least one input image of the plurality of input images using the machine learning-based encoder, and wherein combining the timing information associated with capture of the plurality of input images comprises adding the timing information to the downscaled multi-scale feature information;
flattening features associated with multi-scale feature information generated from at least one input image of the plurality of input images using the machine learning-based encoder, and wherein combining the timing information associated with capture of the plurality of input images comprises adding the timing information to the flattening features;
keys and values generated from multi-scale feature information using the machine learning-based encoder, and wherein combining the timing information associated with capture of the plurality of input images comprises adding the timing information to the keys and the values before linearization of the keys and the values; or
queries generated from multi-scale feature information using the machine learning-based encoder, and wherein combining the timing information associated with capture of the plurality of input images comprises adding the timing information to the queries before determining an attention using the queries.

16. The method of claim 11, further comprising:
determining a cross-view attention between the plurality of spatial views based on the plurality of features generated from the plurality of input images associated with the plurality of spatial views; and
determining depth associated with the plurality of input images based on the cross-view attention.

17. An apparatus for processing image data, the apparatus comprising:
at least one memory; and
at least one processor coupled to the at least one memory and configured to:
obtain a plurality of input images associated with a plurality of spatial views of a scene;
generate, using a machine learning system, a plurality of predicted images associated with the plurality of spatial views; and
generate a plurality of features from each of the plurality of spatial views at a first time.

18. The apparatus of claim 17, wherein the at least one processor is configured to:
warp each image from the plurality of predicted images based on extrinsic information of a corresponding image sensor.

19. The apparatus of claim 17, wherein each of the plurality of predicted images is generated to correspond to an of estimate the plurality of features at the first time.

20. The apparatus of claim 17, wherein the at least one processor is configured to:
determine a cross-view attention between the plurality of spatial views based on the plurality of features generated from the plurality of predicted images associated with the plurality of spatial views; and
determine depth associated with the plurality of predicted images based on the cross-view attention.
